(19) United States
(12) Patent Application Publication
(10) Pub. No.: US 2012/0250547 A1
(43) Pub. Date: Oct. 4, 2012

(54) WIRELESS COMMUNICATION DEVICE, WIRELESS COMMUNICATION METHOD, AND WIRELESS COMMUNICATION SYSTEM

(75) Inventors: Chihiro Fujita, Kanagawa (JP); Hideki Iwami, Saitama (JP); Osamu Yoshimura, Kanagawa (JP)

(73) Assignee: SONY CORPORATION, Tokyo (JP)

(21) Appl. No.: 13/428,487

(22) Filed: Mar. 23, 2012

(30) Foreign Application Priority Data
Mar. 31, 2011 (JP) 2011-078462

(51) Int. Cl. H04W 4/00; H04W 4/06; H04W 24/00

(52) U.S. Cl. 370/252; 370/328; 370/312

(57) ABSTRACT

A wireless communication device includes: a data transmission unit that transmits data to one or more receiving terminals; and a communication mode determination unit that determines a communication mode in which the data is transmitted from the data transmission unit, wherein the communication mode determination unit selects a first communication mode in which unicast communication is used when the number of receiving terminals to which the data is transmitted is equal to or less than a predetermined number, and selects a second communication mode in which unicast communication is performed to one or some of receiving terminals as a destination and the other receiving terminals than the destination also receive packets in unicast communication when the number of receiving terminals to which the data is transmitted exceeds the predetermined number.

### FIELD

The present disclosure relates to a wireless communication device, a wireless communication method, and a wireless communication system that wirelessly transmit large-volume data of moving images or the like, and specifically, to a wireless communication device, a wireless communication method, and a wireless communication system that wirelessly transmit large-volume data to plural terminals while appropriately using unicast communication or multicast communication.

### BACKGROUND

Recently, proposals and commercialization of systems that wirelessly transmit large-volume data of moving images or the like have been increased and the transmission capacity of wireless communication has been increased. As independent development of wireless communication systems for large-volume data transmission makes the costs higher, IEEE 802.11 that has been widespread as standards of wireless LAN (local area network) may often be applied.

General wireless LAN communication modes may include unicast communication that transmits data to one terminal and multicast communication that transmits the same data to plural terminals.

In the unicast communication, there is a mechanism, when a packet is not properly transmitted due to the condition of the transmission line, of retransmitting the packet. Thereby, if the condition of the transmission line is deteriorated, the packet can be transmitted properly, however, the amount of transmission delay of the packet is increased by the retransmission. Accordingly, in the packet retransmission procedure, the maximum number of retransmissions is determined.

On the other hand, in the multicast communication, the same data may be transmitted to plural receiving terminals at a time, and use of the transmission band can be suppressed. However, information as to whether or not a packet is properly transmitted is not returned from the respective receiving terminals, and, if the packet is not properly transmitted, retransmission may be impossible. That is, in the multicast communication, there is a problem that, though data can be transmitted to plural terminals with low delay if the condition of the transmission line is good, transmission of packets may be impossible if the condition of the transmission line is poor.

When the same information is wirelessly transmitted to plural terminals, if the unicast communication is performed despite the large number of terminals, the delay time becomes greater until the transmission to all terminals is finished. Further, if the condition of the transmission line is poor, the frequency of retransmission of packets is higher and the transmission delay time is greater. On the other hand, according to the multicast communication, the same information may be transmitted to many terminals at a time and the transmission band is saved, however, if the condition of the transmission line is poor, transmission of packets may be impossible.

For example, a content provider characterized, in response to a content distribution request from a client, by selecting unicast or multicast distribution according to the band required for content distribution and instructing the content distribution based on the selection result has been proposed (for example, see Patent Document 1 (JP-A-2002-353964)).

Further, a communication terminal of dynamically switching whether to use the multicast reception or unicast reception in reflection of the radio wave environment status with respect to each terminal has been proposed (for example, see Patent Document 2 (JP-A-2006-333182)).

Furthermore, a system of selecting one of unicast communication or multicast communication according to the type of transmission data has been proposed (for example, see Patent Document 3 (JP-A-2004-153312) and Patent Document 4 (JP-A-2006-101148)).

In addition, a wireless communication network of performing information distribution by selecting which communication to use based on overall evaluation values in response to plural parameters corresponding to the respective communication lines in consideration of the network communication status and network topology information has been proposed (for example, see Patent Document 5 (JP-A-2009-206837)).

In real-time transmission systems of moving images and sound or the like, to realize fixed delay, the time for processing data at the receiving terminal side may be determined. In the system, it is not sufficient to just properly transmit data, but it is important to transmit data within a fixed delay time.

For example, synchronization is established between the transmission side and the reception side, time stamp information added to a packet at the transmission side is acquired at the reception side, the acquisition time is checked, and thereby, the amount of transmission delay of the packet may be measured. To realize fixed delay, at the reception side, the packet with the delay time over the fixed delay time is discarded and decoding of moving images is performed using the other data only. Therefore, the packet to be discarded at the large number of retransmissions wastes the wireless band and takes away the transmission chances of the other terminals. Such a terminal may not only receive the information by itself but may also damage reception of the other terminals.

In the case where real-time transmission is performed for plural receiving terminals, in the unicast communication, if the number of receiving terminals is larger, the delay time to finish transmission to all terminals is greater, and realization of fixed delay becomes difficult. On the other hand, in the multicast communication, the same information is transmitted to many terminals at a time, and the delay time is not problematic and the transmission band is saved. However, there is no mechanism of retransmission, if the condition of the transmission line is poor, data transmission quality becomes lower such that moving images are interrupted.

### SUMMARY

It is desirable to provide an advantageous wireless communication device, wireless communication method, and wireless communication system that can wirelessly transmit large-volume data to plural terminals while appropriately using unicast communication or multicast communication.

It is also desirable to provide an advantageous wireless communication device, wireless communication method, and wireless communication system that can realize fixed delay while appropriately using unicast communication or multicast communication in response to the number of receiving terminals and the condition of the transmission line in a real-time transmission system of moving images or the like.

One embodiment of the present disclosure is directed to a wireless communication device including a data transmission unit that transmits data to one or more receiving terminals, and a communication mode determination unit that determines a communication mode in which the data is transmitted from the data transmission unit, wherein the communication mode determination unit selects a first communication mode in which unicast communication is used when the number of receiving terminals to which the data is transmitted is equal to or less than a predetermined number, and selects a second communication mode in which unicast communication is performed to one or some of receiving terminals as a destination and the other receiving terminals than the destination also receive packets in unicast communication when the number of receiving terminals to which the data is transmitted exceeds the predetermined number.

One embodiment of the present disclosure is directed to a wireless communication device which returns an acknowledgement when receiving a packet to itself, and receives a packet to another destination, but returning no acknowledgement when selected as a terminal that receives the packet to the other destination in unicast communication.

One embodiment of the present invention is directed to a wireless communication method including measuring the number of receiving terminals to which data is transmitted, selecting a first communication mode in which unicast communication is used when the number of receiving terminals to which the data is transmitted is equal to or less than a predetermined number, selecting a second communication mode in which unicast communication is performed to one or some of receiving terminals as a destination and the other receiving terminals than the destination also receive packets in unicast communication when the number of receiving terminals to which the data is transmitted exceeds the predetermined number, and performing data transmission in the selected communication mode.

One embodiment of the present disclosure is directed to a wireless communication method including receiving data, returning an acknowledgement when receiving a packet to itself, and receiving a packet to another destination, but returning no acknowledgement when selected as a terminal that receives the packet to the other destination in unicast communication.

One embodiment of the present disclosure is directed to a wireless communication device including a data transmission unit that transmits data to one or more receiving terminals by unicast communication, and a maximum number of retransmissions control unit that controls the maximum number of retransmissions in response to the number of receiving terminals as destinations of the unicast communication, wherein the maximum number of retransmissions control unit reduces the maximum number of retransmissions of the receiving terminals when the number of receiving terminals increases.

One embodiment of the present disclosure is directed to the above wireless communication device, wherein the maximum number of retransmissions control unit increases the maximum number of retransmissions of the receiving terminals when the number of receiving terminals decreases.

One embodiment of the present disclosure is directed to a wireless communication device including a reception unit that receives a packet as a destination of unicast communication, and a retransmission control unit that performs retransmission control when the reception packet is lost in the reception unit, wherein the retransmission control unit requests retransmission of the lost packet to the maximum number of retransmissions set in response to the number of receiving terminals as destinations of the unicast communication.

One embodiment of the present disclosure is directed to the wireless communication device, wherein the maximum number of retransmissions decreases when the number of receiving terminals as destinations of the unicast communication increases and the maximum number of retransmissions increases when the number of receiving terminals as destinations of the unicast communication decreases.

One embodiment of the present disclosure is directed to a wireless communication method including measuring the number of receiving terminals to which data is transmitted by unicast communication, reducing the maximum number of retransmissions provided to the receiving terminals and performing unicast communication when the number of receiving terminals increases, and increasing the maximum number of retransmissions provided to the receiving terminals and performing unicast communication when the number of receiving terminals decreases.

One embodiment of the present disclosure is directed to a wireless communication method including receiving a packet as a destination of unicast communication, and requesting, when the reception packet is lost in a reception unit, retransmission of the lost packet to the maximum number of retransmissions set in response to the number of receiving terminals as destinations of the unicast communication.

One embodiment of the present disclosure is directed to a wireless communication device including a data transmission unit that transmits data to one or more receiving terminals, and a communication mode determination unit that determines a communication mode in which the data is transmitted from the data transmission unit, wherein the communication mode determination unit selects a second communication mode in which unicast communication is performed to one or some of receiving terminals as a destination and the other receiving terminals than the destination also receive packets in unicast communication when a packet loss rate in the receiving terminal is equal to or less than a first threshold value, and selects a first communication mode in which unicast communication is used when the packet loss rate in the receiving terminal exceeds the first threshold value.

One embodiment of the present disclosure is directed to the wireless communication device, wherein the communication mode determination unit selects multicast communication when the packet loss rate in the receiving terminal is equal to or less than a second threshold value lower than the first threshold value.

One embodiment of the present disclosure is directed to a wireless communication method including measuring a packet loss rate in a receiving terminal to which data is transmitted, selecting a second communication mode in which unicast communication is performed to one or some of receiving terminals as a destination and the other receiving terminals than the destination also receive packets in unicast communication when the packet loss rate is equal to or less than a first threshold value, selecting a first communication mode in which unicast communication is used when the packet loss rate exceeds the first threshold value, and performing data transmission in the selected communication mode.

One embodiment of the present disclosure is directed to a wireless communication device including a data transmission unit that transmits data to one or more receiving terminals, a packet loss rate measurement unit that measures a packet loss rate in each receiving terminal, and a service ending processing unit that ends service of transmitting data to the receiving terminal with the higher packet loss rate.

One embodiment of the present disclosure is directed to a wireless communication device including a reception unit that receives a packet transmitted from a transmitting terminal, a packet loss rate measurement unit that measures a packet loss rate in the reception unit, and a service ending processing unit that ends service from the transmitting terminal when the packet loss rate is higher.

One embodiment of the present disclosure is directed to a wireless communication method including measuring a packet loss rate in each receiving terminal to which data is transmitted, and ending service of transmitting data to the receiving terminal with the higher packet loss rate.

One embodiment of the present disclosure is directed to a wireless communication method including measuring a packet loss rate from a transmitting terminal, and ending service from the transmitting terminal when the packet loss rate is higher.

One embodiment of the present disclosure is directed to a wireless communication system including a transmitting terminal that distributes data, and one or more receiving terminals that receive data distributed from the transmitting terminal, wherein the transmitting terminal distributes data in a first communication mode of unicast communication when the number of the receiving terminals is equal to or less than a predetermined number, the transmitting terminal distributes data in a second communication mode when the number of the receiving terminals exceeds the predetermined number, and the transmitting terminal performs unicast communication to one or some of the receiving terminals as a destination and the other receiving terminals than the destination also receive packets in unicast communication in the second communication mode.

Note that “system” here refers to a logical set of plural devices (or functional modules realizing specific functions), and the respective devices and functional modules may be provided within a single casing or not (this is the same with the following cases).

One embodiment of the present disclosure is directed to a wireless communication system including a transmitting terminal that distributes data by unicast communication, and one or more receiving terminals that receive data distributed from the transmitting terminal by unicast communication, and reducing the maximum number of retransmissions of the receiving terminals when the number of receiving terminals increases.

One embodiment of the present disclosure is directed to a wireless communication system including a transmitting terminal that distributes data, and one or more receiving terminals that receive data distributed from the transmitting terminal, wherein the transmitting terminal distributes data in a third communication mode of multicast communication or in a second communication mode when a packet loss rate in the receiving terminal is equal to or less than a predetermined threshold value, the transmitting terminal distributes data in a first communication mode of unicast communication when the packet loss rate in the receiving terminal exceeds the predetermined threshold value, and the transmitting terminal performs unicast communication to one or some of the receiving terminals as a destination and the other receiving terminals than the destination also receive packets in unicast communication in the second communication mode.

One embodiment of the present disclosure is directed to a wireless communication system including a transmitting terminal that distributes data, and one or more receiving terminals that receive data distributed from the transmitting terminal, and ending service of distributing data from the transmitting terminal to the receiving terminal with a higher packet loss rate.

According to the embodiments of the present disclosure, in the real-time transmission system of moving images or the like, an advantageous wireless communication device, wireless communication method, and wireless communication system that can realize fixed delay while appropriately using unicast communication or multicast communication in response to the number of receiving terminals and the condition of the transmission line may be provided.

According to the embodiments of the present disclosure, for example, when the distribution service of fixed delay data of real-time transmission of moving image data or the like is performed, if the number of receiving terminals is smaller, unicast communication is performed, and thereby, the packet loss rate may be reduced. Further, if the number of receiving terminals is larger, multicast communication is performed, and thereby, the transmission delay time of the packet may be reduced and the wasted band may be reduced. Alternatively, if the number of receiving terminals is larger, communication is performed in the sniffer mode, and thereby, the wasted band may be reduced while the packet loss is reduced.

Further, according to the embodiments of the present disclosure, when the distribution service of fixed delay data to the plural receiving terminals is performed by unicast communication, the maximum number of retransmissions is reduced if the number of destination terminals is larger, and thereby, the transmission delay time of the packet may be reduced and the wasted band may be reduced.

Furthermore, according to the embodiments of the present disclosure, the packet loss rate PLR with respect to each receiving terminal is measured, and thereby, the communication modes suitable for the condition of the transmission line can be selected and switched, the wasted band may be reduced, and the packet loss rate may be reduced.

In addition, according to the embodiments of the present disclosure, when the distribution service of fixed delay data of moving image real-time transmission or the like is performed for plural receiving terminals, the communication with the receiving terminal with the larger packet loss rate is ended, and thereby, the wasted band may be reduced.

In the communication system according to the embodiments of the present disclosure, the amount of transmission delay and the packet loss rate are notified to the user of each receiving terminal, and thereby, the user can perform setting of the amount of delay and the communication mode of the system.

The other purposes, features, and advantages according to the embodiments of the present disclosure will be clear by the more detailed explanation according to the following embodiments of the present disclosure and accompanying drawings.

### BRIEF DESCRIPTION OF THE DRAWINGS

FIG. 1 shows an example of a communication system 100 to which an embodiment of the present disclosure is applied.

FIG. 2 shows a configuration example of a communication device as a transmitting terminal 110.

FIG. 3 shows a format of an RTP packet.

FIG. 4 shows a configuration example of a communication device as a receiving terminal 120.

FIG. 5 is a diagram for explanation of a method of determining a communication mode in response to the number N of receiving terminals 120 that receive the same transmission data from the transmitting terminal 110 (in the case where the number N of receiving terminals 120 exceeds a threshold value a and multicast communication is selected).

FIG. 6 is a diagram for explanation of a method of determining a communication mode in response to the number N of receiving terminals 120 that receive the same transmission data from the transmitting terminal 110 (in the case where the number N of receiving terminals 120 exceeds the threshold value a and sniffer-mode communication is selected).

FIG. 7 is a diagram for explanation of a method of determining a communication mode in response to the number N of receiving terminals 120 that receive the same transmission data from the transmitting terminal 110 (in the case where the number N of receiving terminals 120 is within the threshold value a and unicast communication is selected).

FIG. 8 is a flowchart showing a processing procedure of selecting a communication mode in response to the number N of receiving terminals 120 that receive the same transmission data from the transmitting terminal 110.

FIG. 9 is a flowchart showing another processing procedure of selecting a communication mode in response to the number N of receiving terminals 120 that receive the same transmission data from the transmitting terminal 110.

FIG. 10 is a flowchart showing a processing procedure for setting the maximum number of retransmissions in response to the number of receiving terminals 120 when unicast communication is selected in the communication system 100.

FIG. 11A shows a condition of switching communication modes of transmitting the same data from the transmitting terminal 110 to plural receiving terminals 120-1, 120-2, . . . , 120-N in response to a packet loss rate PLR (in the case where all communication systems are used).

FIG. 11B shows a condition of switching communication modes of transmitting the same data from the transmitting terminal 110 to plural receiving terminals 120-1, 120-2, . . . , 120-N in response to the packet loss rate PLR (in the case where only the multicast mode and the unicast mode are used).

FIG. 11C shows a condition of switching communication modes of transmitting the same data from the transmitting terminal 110 to plural receiving terminals 120-1, 120-2, . . . , 120-N in response to the packet loss rate PLR (in the case where only the sniffer mode and the unicast mode are used).

FIG. 12A is a flowchart showing a processing procedure of selecting a communication mode in response to the packet loss rate PLR in the communication system 100.

FIG. 12B is a flowchart showing a processing procedure of selecting a communication mode in response to a packet loss rate PLR in the communication system 100 (in the case where measurement of the packet loss rate PLR and selection of the communication mode are repeated on a regular basis).

FIG. 13 shows a communication sequence example between the transmitting terminal 110 and the receiving terminal 120 when the communication mode is selected in response to the packet loss rate PLR.

FIG. 14A shows a communication sequence example of switching communication modes in response to a request from the transmitting terminal 110.

FIG. 14B shows a communication sequence example of switching communication modes in response to a request from the receiving terminal 120.

FIG. 15 shows a condition of ending service to a receiving terminal for which a condition of the transmission line is deteriorated due to movement in the communication system 100.

FIG. 16 is a flowchart showing a processing procedure of ending service to the receiving terminal 120 due to increase of the packet loss rate PLR.

FIG. 17A shows a communication sequence example when service to the receiving terminal 120 with the increased packet loss rate PLR is ended.

FIG. 17B shows another communication sequence example when service to the receiving terminal 120 with the increased packet loss rate PLR is ended.

### DETAILED DESCRIPTION

Hereinafter, embodiments of the present disclosure will be explained in detail with reference to the drawings.

### <System Configuration>

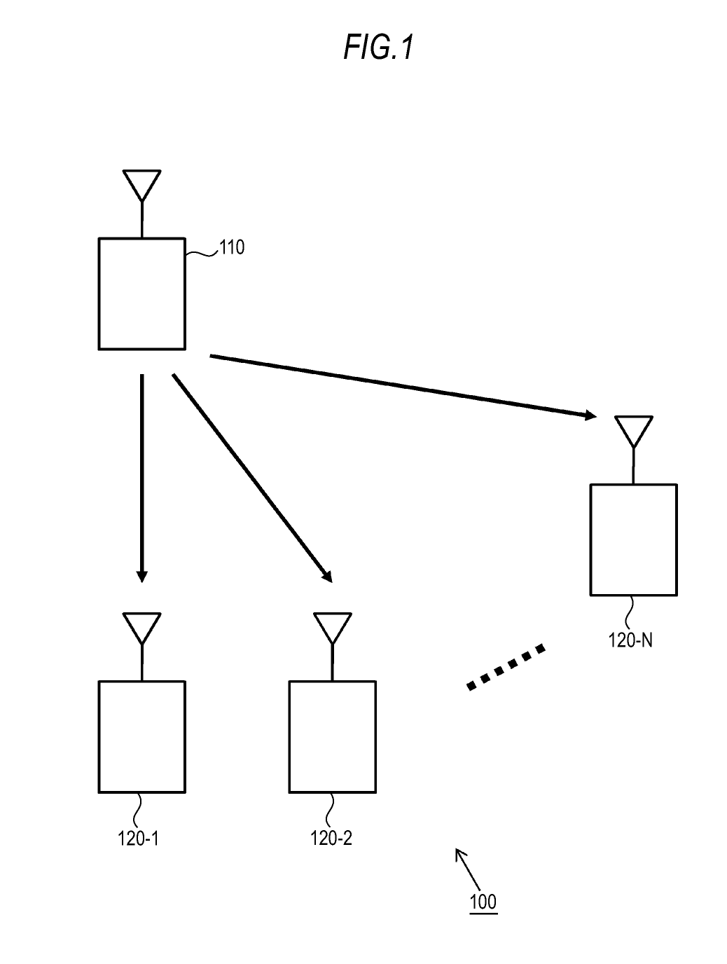

FIG. 1 shows an example of a communication system 100 to which an embodiment of the present disclosure is applied. The illustrated communication system 100 includes one transmitting terminal 110 and one or more receiving terminals 120-1, 120-2, . . . , 120-N (here, N is an integer number equal to or more than “1”). From the transmitting terminal 110 to the respective receiving terminals 120-1, . . . , for example, data transmission of moving images, sound, or the like is performed and there is a technical challenge of realization of fixed delay.

### <Configuration of Transmitting Terminal>

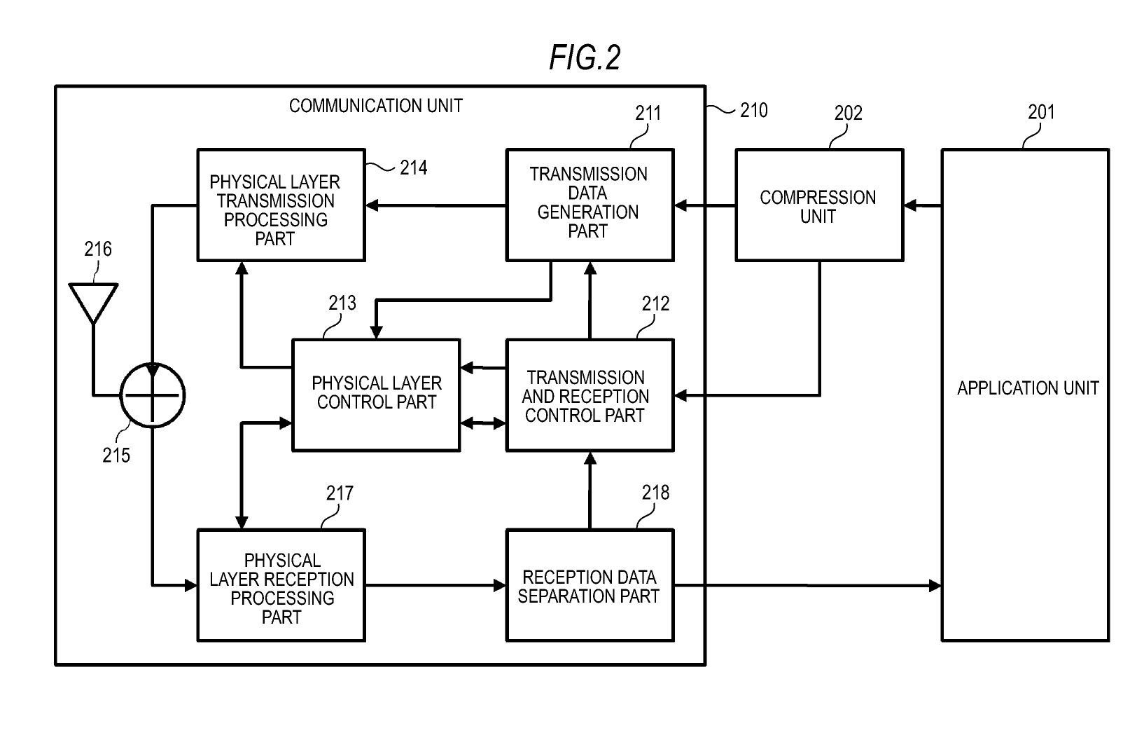

FIG. 2 shows a configuration example of a communication device as the transmitting terminal 110. The illustrated communication device includes an application unit 201, a compression unit 202, and a communication unit 210.

The application unit 201 acquires predetermined transmission data of moving images, sound, or the like in response to operation by a user and supplies the data to the compression unit 202. As below, for convenience of explanation, the transmission data is image data. Further, the application unit 201 supplies control data used for control of the user interface for the user to operate the respective applications and control of communication to the compression unit 202.

When the image data and the control data are supplied from the application unit 201, the compression unit 202 encodes the image data and multiplexes the control data in response to control data information.

The communication unit 210 includes a transmission data generation part 211, a transmission and reception control part 212, a physical layer control part 213, a physical layer transmission processing part 214, a switch part 215, an antenna part 216, a physical layer reception processing part 217, and a reception data separation part 218.

The transmission data generation part 211 generates a communication packet containing the image data output from the compression unit 202. For example, when communication according to a TCP (Transmission Control Protocol) having a retransmission function or a UDP (User Datagram Protocol) with the retransmission function omitted, or an IP (internet protocol) is performed, the transmission data generation part 211 generates an IP packet by adding a TCP header or a UDP header and terminal identification information to the image data. Further, the transmission data generation part 211 adds time stamp information to the IP packet for measurement of transmission delay. As an example of time stamp addition, there is a conceivable method of generating a communication packet as an RTP packet.

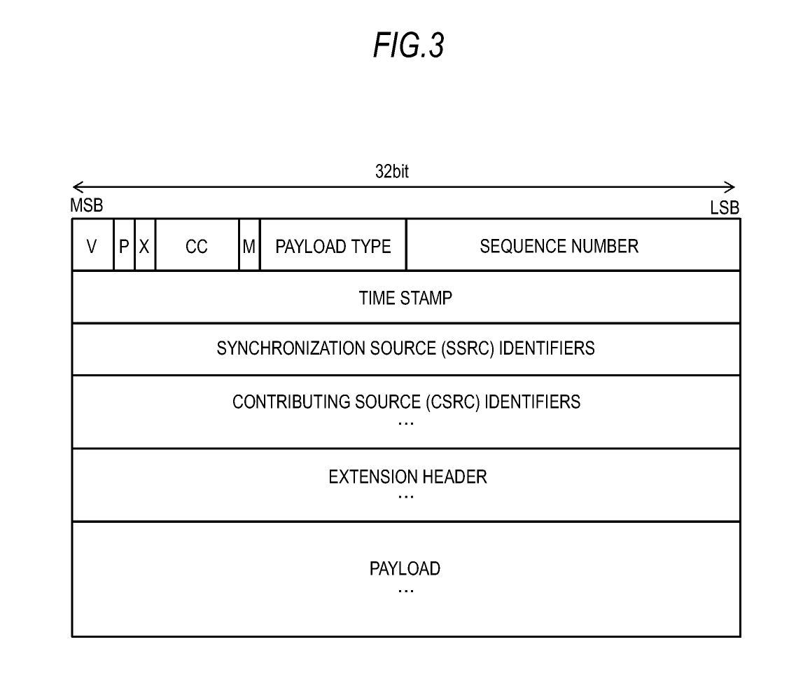

Here, an RTP (Real-time Transport Protocol) is a protocol of sending out a data stream of moving images, sound, or the like on the IP network in real time. FIG. 3 shows a format of an RTP packet. In FIG. 3, a time stamp is inserted in the second word from the top. The time stamp is generated at the transmission side of the packet based on a counter, and the amount of transmission delay from transmission to reception can be measured by synthesizing the counters at the transmission side and the reception side.

Returning to FIG. 2 again, the configuration of the transmitting terminal will be explained. The transmission and reception control part 212 performs control of a MAC (Media Access Control) layer of a wireless LAN, for example. When distribution service of fixed delay data such as moving image real-time transmission is performed, for example, the transmission and reception control part 212 selects one communication mode of unicast communication, multicast communication or a sniffer mode, which will be described later, and switches the communication modes in response to the number N of the receiving terminals 120 in service and the condition of the transmission line shown by a packet loss rate PLR or the like, and the details will be described later.

The physical layer control part 213 controls a physical layer according to an instruction from the transmission and reception control part 212 or the transmission data generation part 211. The physical layer transmission processing part 214 starts operation according to a request of the physical layer control part 213, and outputs the communication packet supplied from the transmission data generation part 211 to the switch part 215.

The switch part 215 has a function of switching transmission and reception of data. Specifically, the switch part 215 transmits the communication packet to the antenna part 216 when the communication packet is supplied from the physical layer transmission processing part 214, and sends it out to a wireless transmission line. Further, when the communication packet is received via the antenna part 216, the switch part 215 supplies the received packet to the physical layer reception processing part 217.

The physical layer reception processing part 217 starts operation according to a request of the physical layer control part 213, and supplies the reception packet to the reception data separation part 218.

The reception data separation part 218 analyzes the reception packet supplied from the physical layer reception processing part 217, separates data to be transferred to the application unit 201, and outputs it to the application unit 201. For example, the reception data separation part 218 may identify the data to be transferred to the application unit 201 by referring to a port number of the TCP header or the UDP header contained in the reception packet.

### <Configuration of Receiving Terminal>

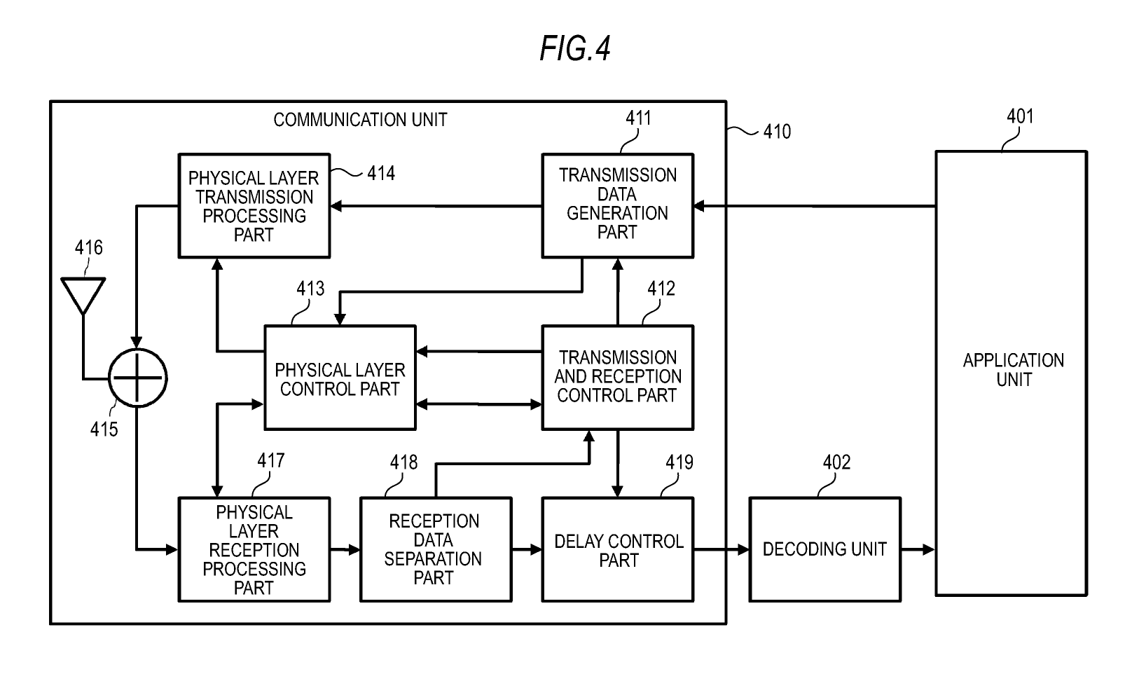

FIG. 4 shows a configuration example of a communication device as the receiving terminal 120. The illustrated communication device includes a communication unit 410, a decoding unit 402, and an application unit 401.

The communication unit 410 includes a transmission data generation part 411, a transmission and reception control part 412, a physical layer control part 413, a physical layer transmission processing part 414, a switch part 415, an antenna part 416, a physical layer reception processing part 417, a reception data separation part 418, and a delay control part 419.

The transmission data generation part 411 reads out the data to be transmitted to the transmitting terminal 110 and generates a transmission packet according to a request of the transmission and reception control part 412. For example, the transmission data generation part 411 generates an IP packet and outputs it to the physical layer transmission processing part 414.

The transmission and reception control part 412 performs control of the MAC layer like the transmission and reception control part 212 of the transmitting terminal 110. Further, the transmission and reception control part 412 measures the packet loss rate PLR of the reception data detected by the reception data separation part 418, for example, which will be described later. Further, the transmission and reception control part 412 computes the amount of transmission delay of the reception packet based on the time stamp information detected by the reception data separation part 418.

The transmission and reception control part 412 applies a retransmission function when performing reception processing of the packet as a destination terminal of unicast communication, and requests retransmission of the packet when losing the packet by ACK return. On the other hand, when performing reception processing by regarding the reception packets to many destinations as the packets to itself as a sniffer terminal, which will be described later or when performing multicast communication, the part does not apply the retransmission function or perform ACK return.

The physical layer control part 413 controls a physical layer according to an instruction from the transmission and reception control part 412 or the transmission data generation part 411. The physical layer transmission processing part 414 starts operation according to a request of the physical layer control part 413, and outputs the communication packet supplied from the transmission data generation part 411 to the switch part 415.

The switch part 415 has a function of switching transmission and reception of data, and transmits the communication packet to the antenna part 416 when the communication packet is supplied from the physical layer transmission processing part 414 and, when the communication packet is received via the antenna part 416, supplies the received packet to the physical layer reception processing part 417.

The physical layer reception processing part 417 starts operation according to a request of the physical layer control part 413, and supplies the reception packet to the reception data separation part 418.

The reception data separation part 418 analyzes the reception packet supplied from the physical layer reception processing part 417, separates received data to be transferred to the decoding unit 402, and outputs it to the decoding unit 402. For example, when communication according to an IP protocol is performed, the reception data separation part 418 may identify the data to be transferred to the decoding part 402 by referring to a destination IP address and a destination port number contained in the reception packet. Further, the reception data separation part 418 acquires time stamp information contained in the reception packet and notifies the transmission and reception control part 412.

The delay control part 419 brings the amount of delay of the reception packet into a fixed value based on the amount of transmission delay computed by the transmission and reception control part 412, and outputs the reception packet to the decoding unit 402. When the amount of transmission delay of the packet is larger than a preset fixed amount of delay, the delay control part 419 discards the reception packet, and thereby, realizes fixed delay. The reception packet discarded in the delay control part 419 for transmission delay is treated as a packet loss in the transmission and reception control part 412 even when the packet is normally reception-processed and decoded, and the packet loss rate is computed. Note that, in the data distribution service in which transmission delay is not problematic, fixing control of the amount of delay may not be performed in the delay control part 419, but all reception packets may be output to the decoding unit 402.

The decoding unit 402 decodes the reception data and outputs it to the application unit 401.

<Switching of Communication Modes depending on Number of Receiving Terminals 120>

In the communication system 100 shown in FIG. 1, when the transmitting terminal 110 performs real-time transmission to the plural receiving terminals 120-1, 120-2, . . . , 120-N, in the unicast communication, if the number of receiving terminals 120 is larger, the delay time to finish transmission to all terminals is greater and realization of the fixed delay becomes difficult. On the other hand, in the multicast communication, the same information is transmitted to many terminals at a time, and the delay time is not problematic. However, there is no mechanism of retransmission, if the condition of the transmission line is poor, data transmission quality becomes lower such that moving images are interrupted.

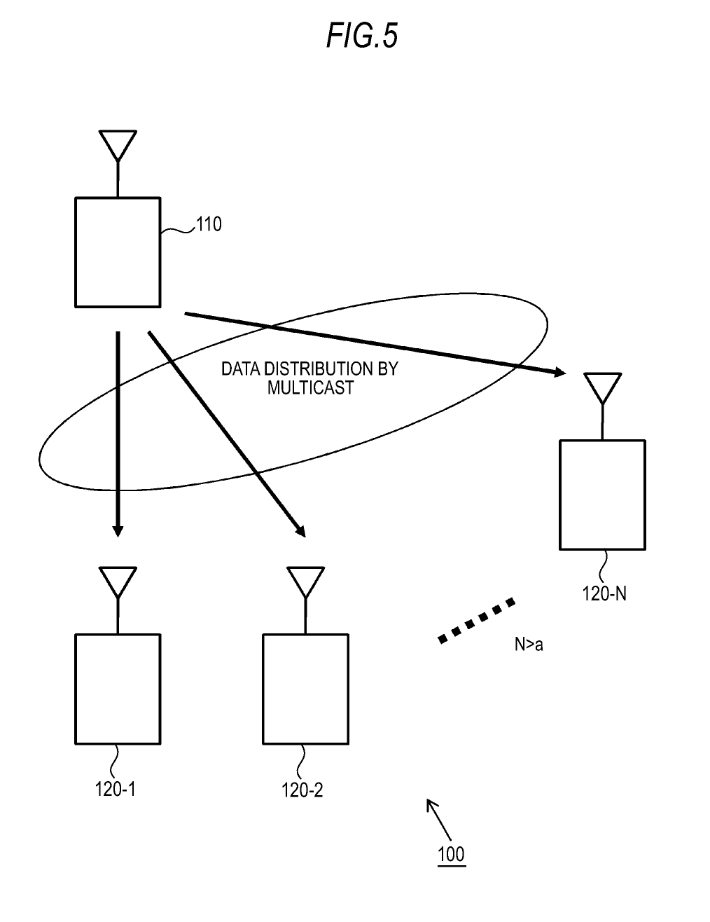

For example, there is a conceivable method for realizing fixed delay while keeping the data transmission quality of the entire communication system 100 by determining the communication mode in response to the number N of receiving terminals 120 that receive transmission data from the transmitting terminal 110 at the same time. A method of determining the communication mode in response to the number N of receiving terminals 120 that receive transmission data from the transmitting terminal 110 at the same time will be explained with reference to FIGS. 5 to 7. Note that a threshold value of the number of receiving terminals 120 when the communication modes are switched is “a”.

FIG. 5 shows the case where the transmitting terminal 110 transmits data using multicast communication when the number N of receiving terminals 120 exceeds the threshold value a.

When the number N of receiving terminals 120 is larger, if unicast communication is performed, the band available for one receiving terminal becomes smaller and the transmission chance decreases, and the amount of transmission delay tends to increase. In the case where fixed delay is realized in the communication system 100, the reception packet for which the amount of transmission delay increases and exceeds the amount of fixed delay is discarded and treated as a packet loss as described above. Therefore, if the number N of receiving terminals 120 exceeds the threshold value a, the transmitting terminal 110 performs multicast communication and prevents the increase of the amount of transmission delay.

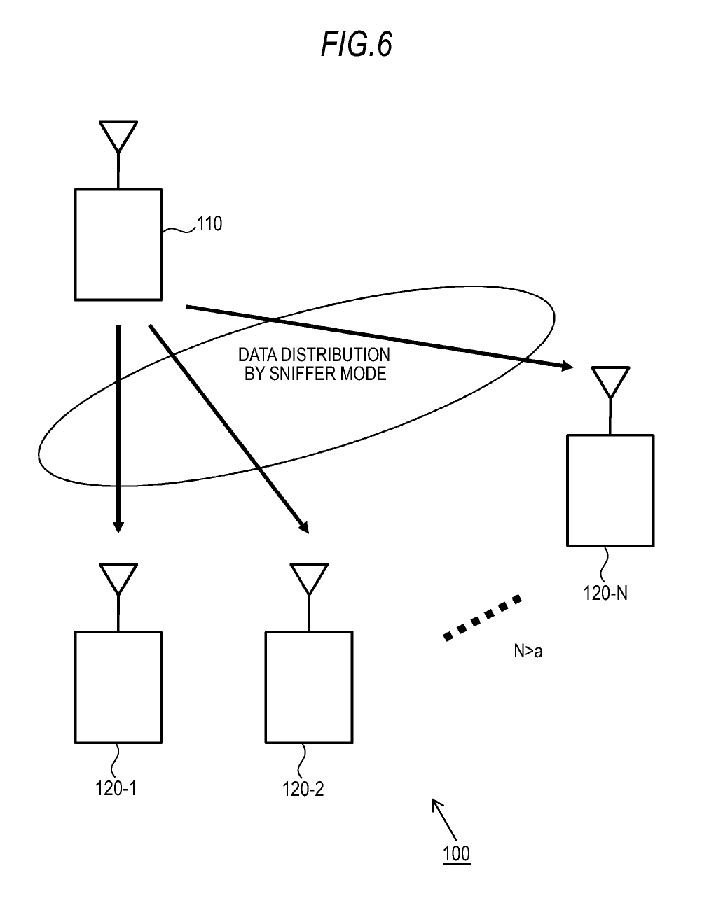

Further, FIG. 6 shows the case where the transmitting terminal 110 transmits data in the sniffer mode, not by multicast when the number N of receiving terminals 120 exceeds the threshold value a.

“Sniffer mode” here is an operation mode of the communication system 100 in which the transmitting terminal 110 performs unicast communication to one of the plural receiving terminals 120-1, 120-2, . . . , 120-N (in the drawing, the receiving terminal 120-N) (or one or more receiving terminals) as a destination, and the other receiving terminals 120-1, 120-2, . . . , 120-(N−1) than the destination receive reception packets as packets to themselves. The other receiving terminals 120-1, 120-2, . . . , 120-(N−1) than the destination will be referred to as “sniffer terminals” as below. Note that, normally, the receiving terminals 120-1, 120-2, . . . , 120-N discard the packets not to themselves. Further, the data desired by the sniffer terminals are data packets containing contents data such as image data and sound data, for example, and the control packets such as ACK are not necessary. Therefore, the sniffer terminals may process the data packets based on the information for identification of the types of the packets contained in the headers, and may not process, but discard the control packets. Further, the sniffer terminals receive the packets, which are not originally to themselves, and do not return reception response signals such as ACK for the received packets.

The receiving terminal 120-N designated as the destination of the packet is a subject of reception and a retransmission procedure is applied thereto. That is, the receiving terminal 120-N may return an acknowledgement (ACK) and can reduce the packet loss rate by retransmission. On the other hand, the retransmission procedure is not applied to the sniffer terminals 120-1, 120-2, . . . , 120-(N−1) which are not the destination of the packet, and the terminals return no acknowledgement (ACK). Therefore, the packets lost by both the destination terminal and the sniffer terminals are retransmitted and the packet loss rates of the sniffer terminals are reduced, however, the packets lost only by the sniffer terminals are not retransmitted.

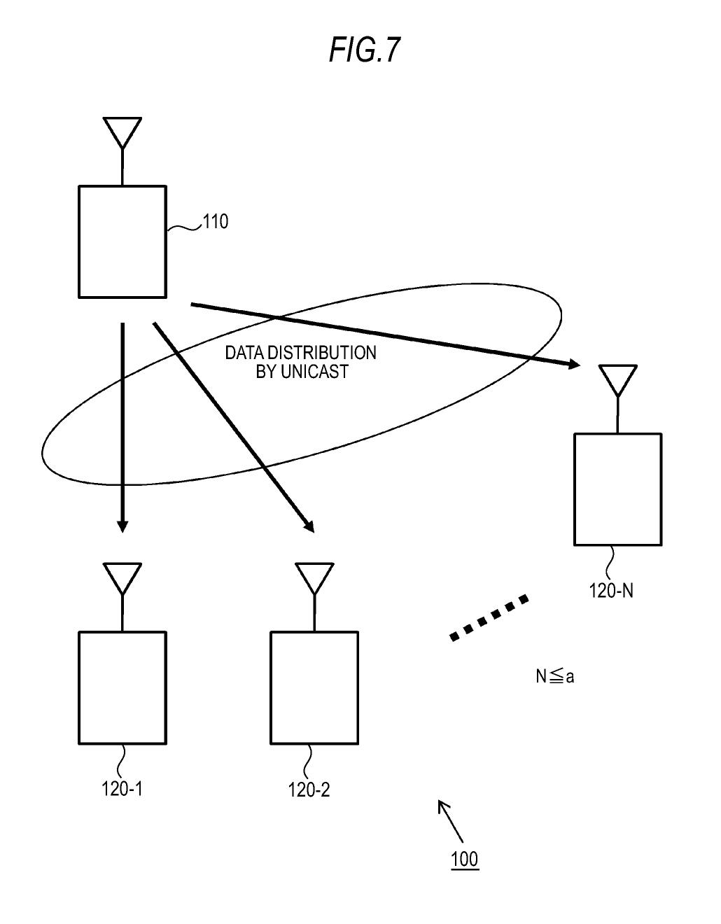

Further, FIG. 7 shows the case where the transmitting terminal 110 transmits data to all receiving terminals 120-1, 120-2, . . . , 120-N using unicast communication when the number N of receiving terminals 120 is within the threshold value a.

When the number N of receiving terminals 120 is smaller, if unicast communication is performed, there is plenty of the band available for one receiving terminal and sufficient transmission chances may be assigned, and the amount of transmission delay is acceptable. All receiving terminals 120-1, 120-2, . . . , 120-N may return acknowledgements (ACK) and stable data transmission by retransmission can be expected.

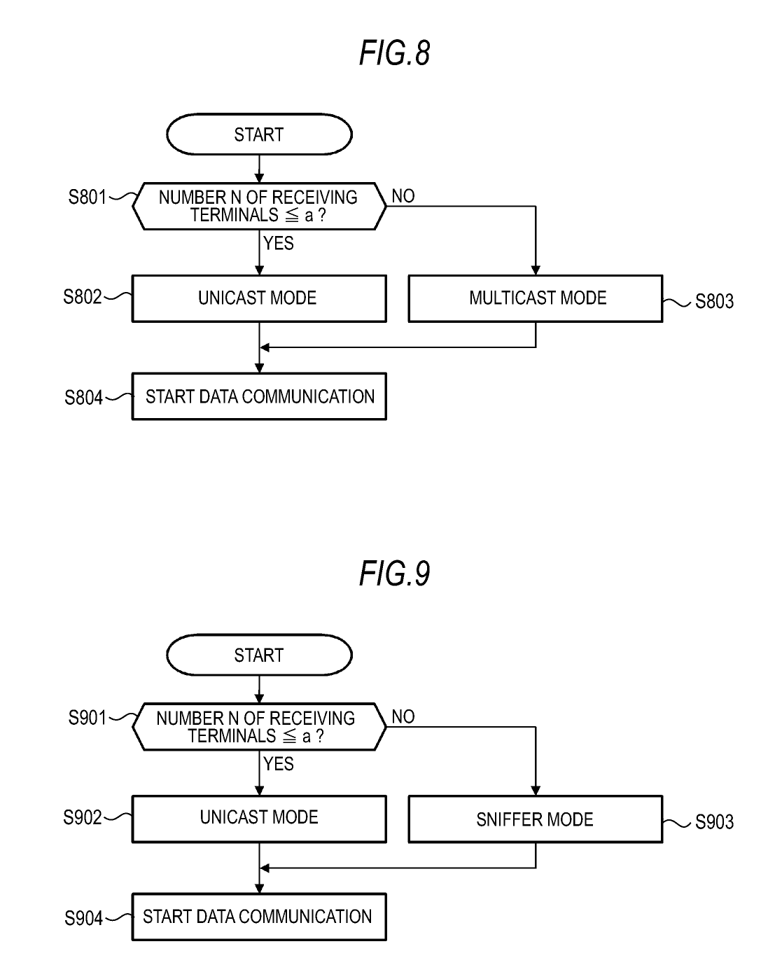

FIG. 8 shows a processing procedure of selecting a communication mode in response to the number N of receiving terminals 120 that receive the same transmission data from the transmitting terminal 110 in the communication system 100 in a form of flowchart. The processing procedure is executed by the transmitting terminal 110, for example. In the processing procedure, one communication mode of the unicast mode or the multicast mode is selected in response to the number N of receiving terminals 120.

First, within the communication system 100, the number N of receiving terminals 120 that receive the same transmission data from the transmitting terminal 110 is acquired and whether or not the number N is equal to or less than the threshold value a is checked (step S801). For example, when the transmitting terminal 110 operates as an access point, the transmitting terminal 110 counts the number of receiving terminals 120 held within the cell of itself as transmission destinations of the same transmission data and makes determination.

Here, if the number N of receiving terminals 120 that receive the same transmission data from the transmitting terminal 110 is equal to or less than the threshold value a (Yes at step S801), the transmitting terminal 110 selects using unicast communication to distribute the same transmission data to all receiving terminals 120-1, 120-2, . . . , 120-N (step S802).

On the other hand, if the number N of receiving terminals 120 that receive the same transmission data from the transmitting terminal 110 exceeds the threshold value a (No at step S801), the transmitting terminal 110 selects using multicast communication to distribute the same transmission data (step S803).

Then, the transmitting terminal 110 starts data transmission in the communication mode selected at step S802 or S803 (step S804).

Further, FIG. 9 shows a processing procedure of selecting a communication mode in response to the number N of receiving terminals 120 that receive the same transmission data from the transmitting terminal 110 in the communication system 100 in a form of flowchart. The processing procedure is executed by the transmitting terminal 110, for example. In the processing procedure, one communication mode of the unicast mode or the sniffer mode is selected in response to the number N of receiving terminals 120.

First, within the communication system 100, the number N of receiving terminals 120 that receive the same transmission data from the transmitting terminal 110 is acquired and whether or not the number N is equal to or less than the threshold value a is checked (step S901). For example, when the transmitting terminal 110 operates as an access point, the transmitting terminal 110 counts the number of receiving terminals 120 held within the cell of itself as transmission destinations of the same transmission data and makes determination.

Here, if the number N of receiving terminals 120 that receive the same transmission data from the transmitting terminal 110 is equal to or less than the threshold value a (Yes at step S901), the transmitting terminal 110 selects using unicast communication to distribute the same transmission data to all receiving terminals 120-1, 120-2, . . . , 120-N (step S902).

On the other hand, if the number N of receiving terminals 120 that receive the same transmission data from the transmitting terminal 110 exceeds the threshold value a (No at step S901), the transmitting terminal 110 selects using the sniffer mode to distribute the same transmission data (step S903).

As described above, in the sniffer mode, unicast communication to one of the plural receiving terminals 120-1, 120-2, . . . , 120-N (or one or more receiving terminals) as a destination is performed, and the other receiving terminals 120-1, 120-2, . . . , 120-(N−1) receive reception packets as packets to themselves as sniffer terminals. The transmitting terminal 100 that has determined transmission of data in the sniffer mode selects one of the plural receiving terminals 120-1, 120-2, . . . , 120-N (or one or more receiving terminals) as a destination and selects the other receiving terminals as sniffer terminals. Note that, normally, the receiving terminals 120-1, 120-2, . . . , 120-N discard the packets not to themselves. Further, the data desired by the sniffer terminals are data packets containing contents data such as image data and sound data, for example, and the control packets such as ACK are not necessary. Therefore, the sniffer terminals may process only the data packets based on the information for identification of the types of the packets contained in the headers, and may not process, but discard the control packets. Further, the sniffer terminals receive the packets, which are not originally to themselves, and do not return reception response signals such as ACK for the received packets.

The receiving terminal designated as the destination of the packet is a subject of reception, may return the acknowledgement (ACK) and can reduce the packet loss rate by retransmission. On the other hand, the retransmission procedure is not applied to the sniffer terminals, and the packets lost only by the sniffer terminals are not retransmitted. Accordingly, at step S803, the receiving terminal with the high packet loss rate may be designated as a destination for reduction of the packet loss rate as the entire system.

Then, the transmitting terminal 110 starts data transmission in the communication mode selected at step S902 or S903 (step S904).

In this manner, in the communication system 100, if the number N of receiving terminals 120 is smaller, the packet loss rate PLR may be reduced by distribution service of fixed delay data by unicast communication. Further, if the number N of receiving terminals 120 is larger, the transmission delay time of packets may be reduced and the wasted band may be reduced by distribution service of fixed delay data by multicast communication. Additionally, the packet loss due to transmission delay may be reduced. If the number N of receiving terminals 120 is larger, the amount of used band may be reduced while the packet loss is reduced by distribution service of fixed delay data by the sniffer mode.

At step S802 of the flowchart shown in FIG. 8 and at step S902 of the flowchart shown in FIG. 9, if the unicast communication is selected, all receiving terminals are the subject of reception and may return the acknowledgements (ACK), and can reduce the packet loss rate by retransmission. Note that the delay time of the packets increases by the amount of retransmission. For example, as the number of receiving terminals 120 as destinations of unicast communication increases, the situation that the frequency of retransmissions of packets is higher in the entire system, the transmission delay time is larger, and the fixed delay may not be realized is assumed. Accordingly, when the unicast communication is selected, there is a conceivable control method of setting the maximum number of retransmissions in response to the increase and decrease of the number of receiving terminals 120. That is, when the number of receiving terminals 120 increases, the maximum number of retransmissions is reduced and the transmission delay time is suppressed from being larger. On the other hand, when the number of receiving terminals 120 decreases, there is plenty of the transmission band, and the maximum number of retransmissions is increased for reduction of the packet loss rate.

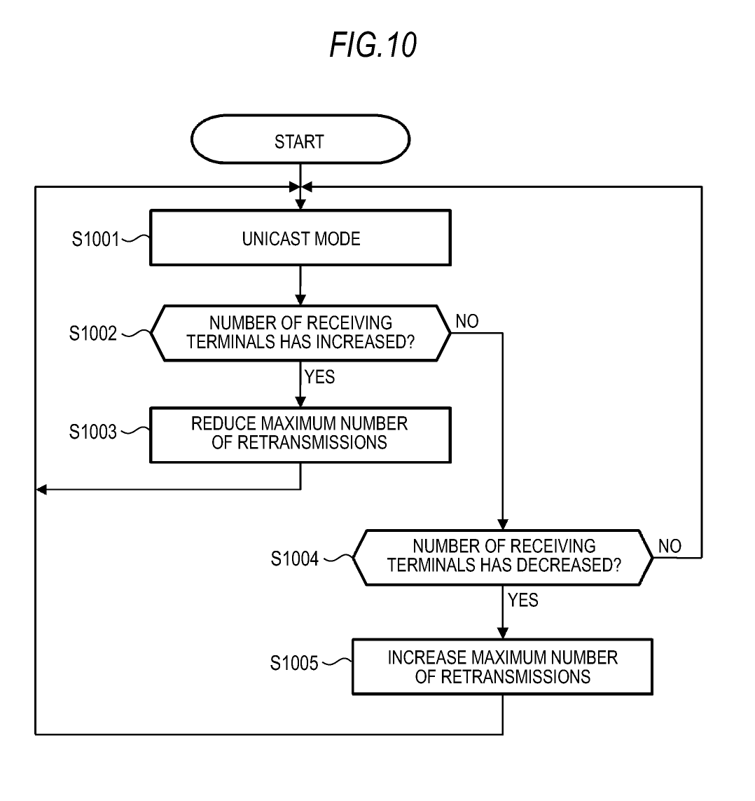

FIG. 10 shows a processing procedure for setting the maximum number of transmissions in response to the number of receiving terminals 120 when unicast communication is selected in the communication system 100 in a form of flowchart. The processing procedure is executed by the transmitting terminal 110, for example.

Before the start of data communication, the number of receiving terminals 120 that receive the same transmission data from the transmitting terminal 110 within the communication system 100 is measured (step S1001).

Then, whether or not the number of receiving terminals 120 has increased is checked (step S1002). Here, if the number of receiving terminals 120 has increased (Yes at step S1002), the maximum number of retransmissions at unicast communication is reduced within the communication system 100 (step S1003). For example, the transmitting terminal 110 sets the reduced maximum number of retransmissions in response to the number of receiving terminals 120, and notifies the respective receiving terminals 120-1, 120-2, . . . as destinations. Then, the process returns to step S1001, and the above described processing is repeatedly executed.

Further, if the number of receiving terminals 120 has not increased (No at step S1002), subsequently, whether or not the number of receiving terminals 120 has decreased is checked (step S1004). Then, if the number of receiving terminals 120 has decreased (Yes at step S1004), the maximum number of retransmissions at unicast communication is increased within the communication system 100 (step S1005). For example, the transmitting terminal 110 sets the increased maximum number of retransmissions in response to the number of receiving terminals 120, and notifies the respective receiving terminals 120-1, 120-2, . . . as destinations. Then, the process returns to step S1001, and the above described processing is repeatedly executed.

For example, the transmitting terminal 110 measures the number of receiving terminals 120 as destinations of the unicast communication within the communication system 100, and sets the maximum number of retransmissions of the respective receiving terminals 120-1, . . . according to the processing procedure shown in FIG. 10. Then, the transmitting terminal 110 notifies the respective receiving terminals 120-1, . . . of the set maximum number of retransmissions. For example, the transmitting terminal 110 may perform notification of the maximum number of retransmissions by superimposition on the transmission data of images or the like.

In this manner, in the communication system 100, when the distribution service of fixed delay data to the plural receiving terminals 120-1, . . . is performed by unicast communication, if the number N of destination terminals is larger, the transmission delay time of packets may be reduced and wasted band may be reduced by reducing the maximum number of retransmissions.

As described above, in the communication system 100 shown in FIG. 1, when the transmitting terminal 110 performs real-time transmission to the plural receiving terminals 120-1, 120-2, . . . , 120-N, in the unicast mode, if the condition of the transmission line is poor, the frequency of retransmission of packets is higher and the transmission delay time is larger, and realization of the fixed delay becomes difficult. On the other hand, in the sniffer mode, the frequency of retransmissions of packets is made lower and, even if the condition of the transmission line is poor, the increase of the transmission delay time may be suppressed. Further, in the multicast mode, the transmission band is saved by transmission of the same information to many terminals at a time, packet retransmission is not performed, and thereby, even if the condition of the transmission line is poor, the transmission delay time may be held constant.

<Switching of Communication Modes depending on Packet Loss Rate>

In FIGS. 5 to 7, the method of determining the communication mode in response to the number N of receiving terminals 120 that receive the transmission data from the transmitting terminal 110 at the same time has been explained. On the other hand, there is a conceivable method of realizing fixed delay while keeping the data transmission quality of the entire communication system 100 by switching the communication modes in response to the packet loss rate (in other words, the condition of the transmission line). The method of determining the communication mode in response to the number N of receiving terminals 120 that receive the transmission data from the transmitting terminal 110 at the same time will be explained with reference to FIGS. 5 to 7. Note that the threshold value of the number of receiving terminals 120 when the communication modes are switched is “a”.

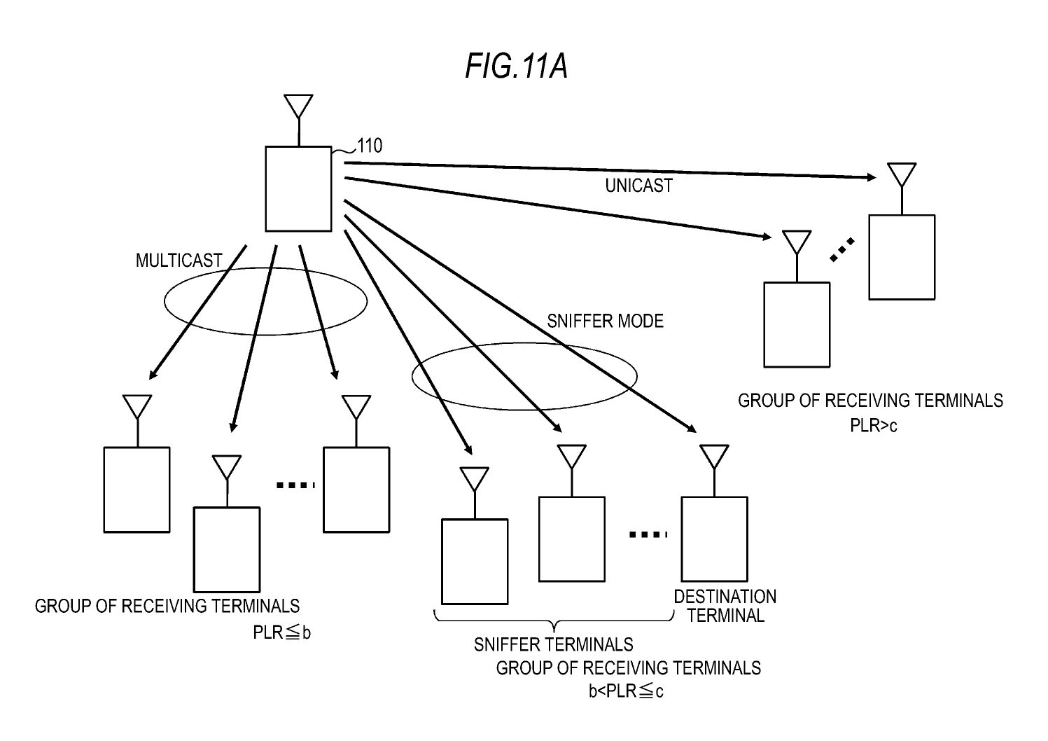

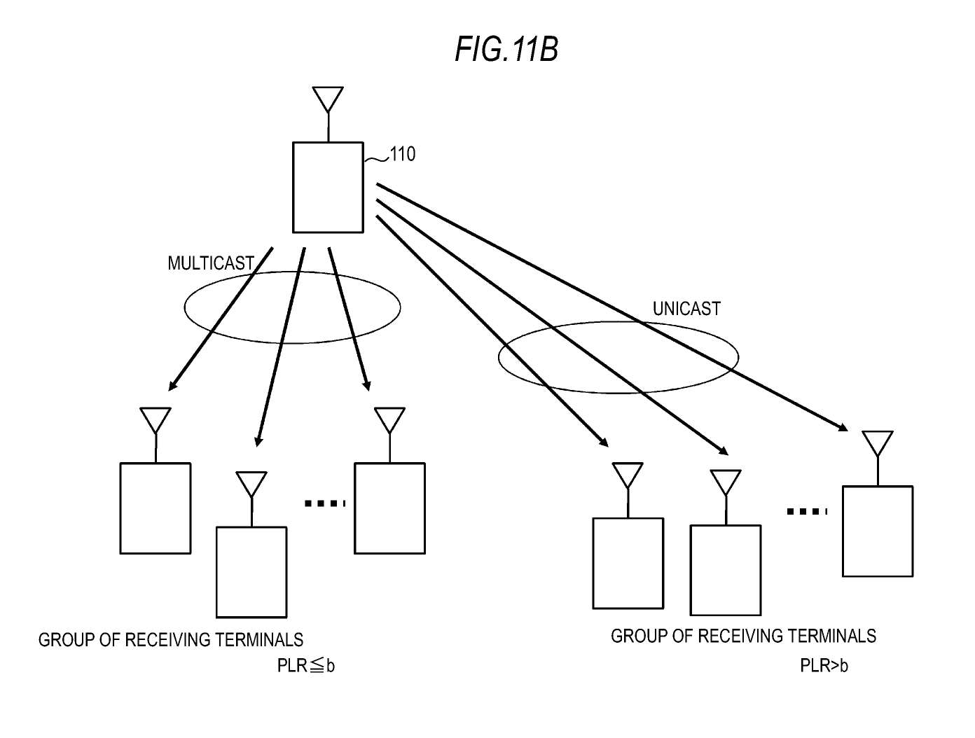

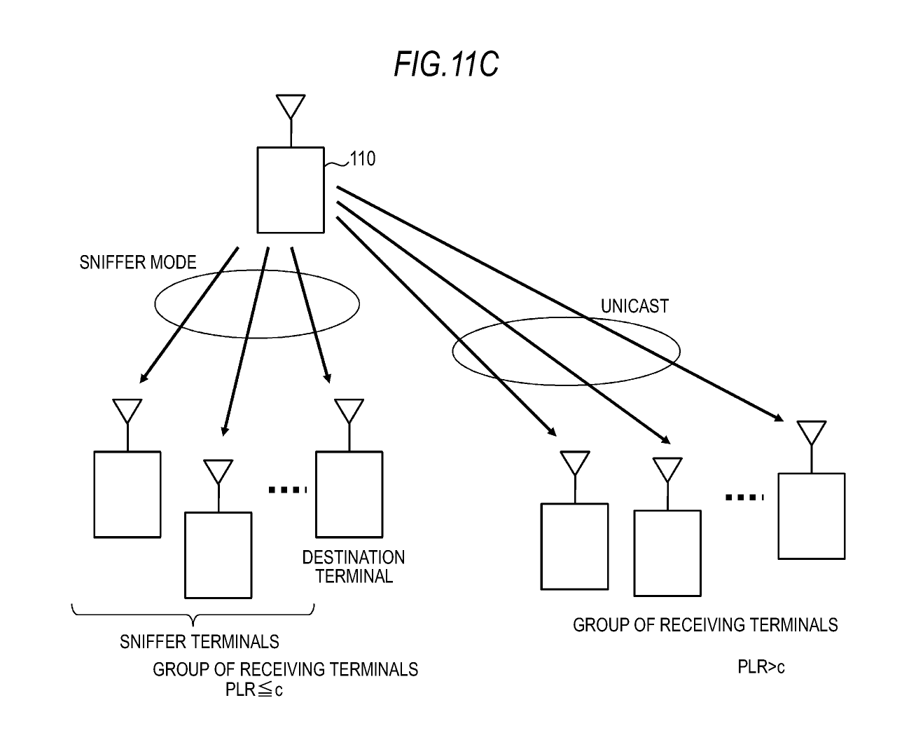

FIG. 11A shows a condition of switching communication modes of transmitting the same data from the transmitting terminal 110 to plural receiving terminals 120-1, 120-2, . . . , 120-N in response to a packet loss rate PLR. In the following description, a threshold value of the packet loss rate PLR when the communication mode is switched from the multicast mode to the sniffer mode is “b” and a threshold value of the packet loss rate PLR when the communication mode is switched from the sniffer mode to the unicast mode is “c” (here, b<c).

If the packet loss rate PLR is equal to or less than the threshold value b, the transmitting terminal 110 selects data transmission using the multicast communication. All receiving terminals 120-1, 120-2, . . . , 120-N within the communication system 100 receive data by multicast. According to the multicast communication, it may be possible to reduce the amount of used band, however, it may be impossible for the respective receiving terminals 120-1, 120-2, . . . , 120-N to return ACK (acknowledgement) packets and thereby the packets may not be retransmitted. Therefore, the multicast communication is effective when the packet loss is smaller. Note that, in the respective receiving terminals 120-1, 120-2, . . . , 120-N, the lost packets may be reproduced by error-correction coding or interpolation.

On the other hand, if the packet loss rate PLR exceeds the threshold value b and equal to or less than the threshold value c, the transmitting terminal 110 selects data transmission using the sniffer mode. As described above, in the sniffer mode, unicast communication to one of the plural receiving terminals 120-1, 120-2, . . . , 120-N (or one or more receiving terminals) as a destination is performed, and the other receiving terminals 120-1, 120-2, . . . , 120-(N−1) receive reception packets by regarding them as packets to themselves as sniffer terminals.

The receiving terminal designated as the destination of the packet is a subject of reception, may return the acknowledgement (ACK), and can reduce the packet loss rate by retransmission. On the other hand, the retransmission procedure is not applied to the sniffer terminals, and the packets lost only by the sniffer terminals are not retransmitted. Accordingly, the transmitting terminal 110 may designate the receiving terminal with the higher packet loss rate as a destination and reduce the packet loss rate as the entire system.

Further, if the packet loss rate PLR exceeds the threshold value c, the transmitting terminal 110 selects data transmission using the unicast communication. All receiving terminals 120-1, 120-2, . . . , 120-N within the communication system 100 are the subject of reception and may return the acknowledgements (ACK), and can reduce the packet loss rates by retransmission. Note that, if the number N of receiving terminals 120 is larger, the frequency of retransmissions of packets is higher, and the larger transmission delay time is concerned.

In the example shown in FIG. 11A, the communication system 100 is sequentially switched among the multicast mode, the sniffer mode, and the unicast mode in response to the packet loss rate PLR, however, all communication modes are not necessarily used. For example, as shown in FIG. 11B, only the multicast mode and the unicast mode may be used or only the sniffer mode and the unicast mode may be used in response to the packet loss rate PLR.

Further, when the redundancy design such as error-correction coding is performed between transmission and reception in the communication system 100, the redundancy may be changed depending on the magnitude of the packet loss rate PLR. For example, if the packet loss rate PLR is lower, the redundancy may be made lower for improvement of the data transmission efficiency, and, if the packet loss rate PLR increases, the redundancy may be made higher for reproduction of the lost packets as much as possible.

Furthermore, the redundancy may be set fixedly with respect to each communication mode in combination with the switching of the communication modes as shown in FIGS. 11A to 11C. For example, in the multicast mode in which it is impossible for all receiving terminals to return the acknowledgements (ACK) and the lost packets are not retransmitted, or, in the sniffer mode in which only part of receiving terminals designated as destinations return the acknowledgements (ACK) and the packets lost by the sniffer terminals are not retransmitted, the redundancy is made higher for reproduction of the lost packets as much as possible. Obviously, regardless of the communication mode, the redundancy may uniquely be linked with the packet loss rate PLR.

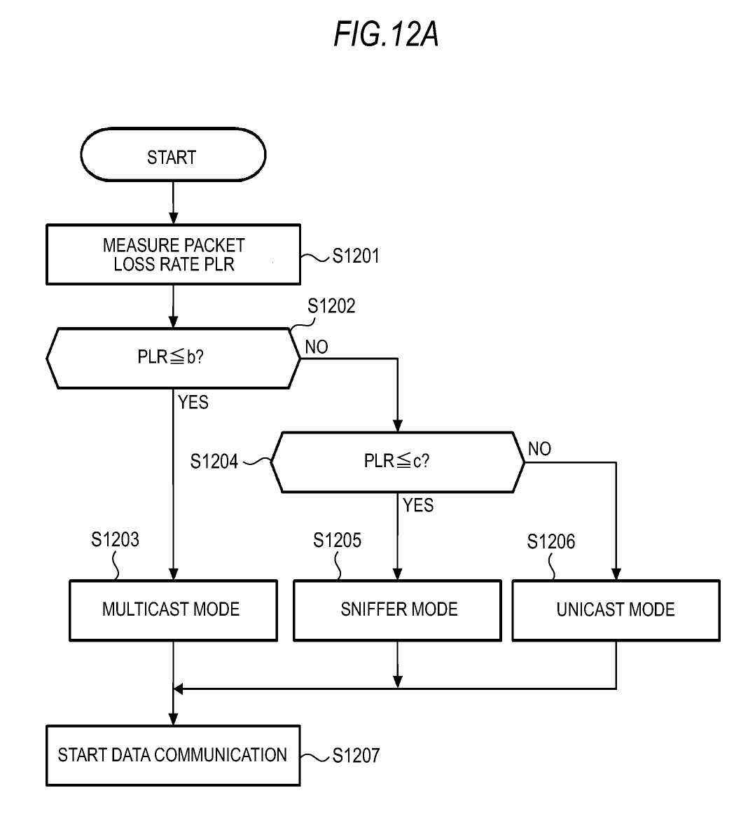

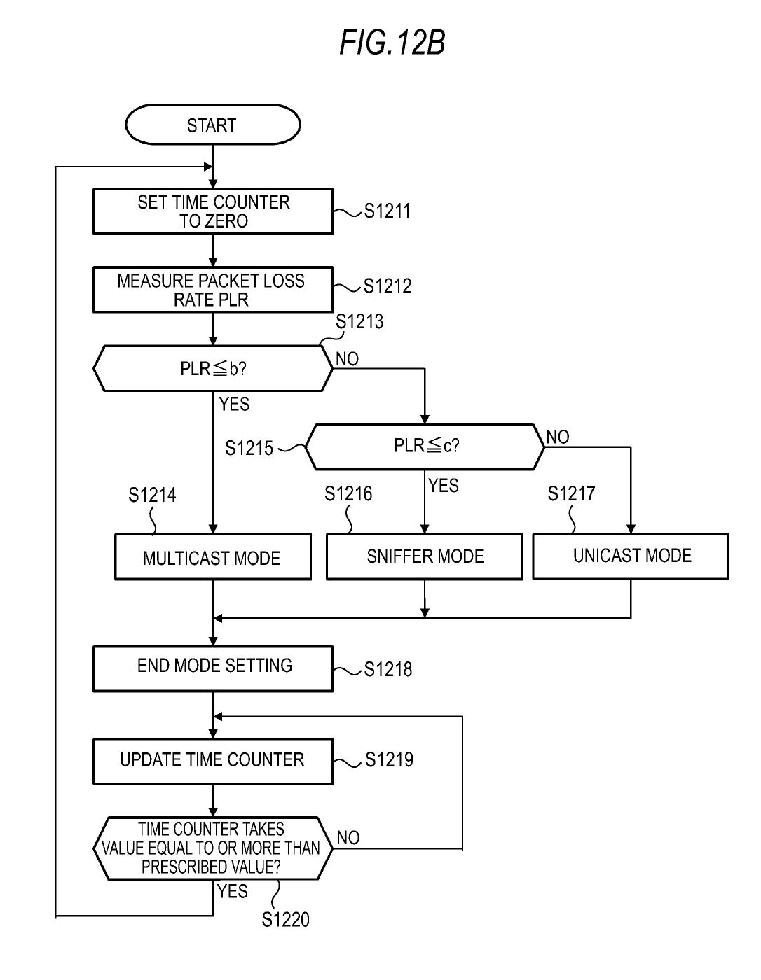

FIG. 12A shows a processing procedure of selecting a communication mode in response to the packet loss rate PLR in the communication system 100 in a form of flowchart. The processing procedure is performed in the transmitting terminal 110, for example.

First, the packet loss rate PLR in the communication system 100 is measured (step S1201). For example, the transmitting terminal 110 transmits test data to the respective receiving terminals 120-1, 120-2, . . . , 120-N, and the reception results of the test data in the respective receiving terminals 120-1, 120-2, . . . , 120-N are compiled by the transmitting terminal 110 for measurement of the packet loss rate PLR of the communication system 100.

Then, whether or not the packet loss rate PLR is equal to or less than the threshold value b is checked (step S1202). Here, if the packet loss rate PLR is equal to or less than the threshold value b (Yes at step S1202), the transmitting terminal 110 selects distribution of the same transmission data using the multicast communication (step S1203).

On the other hand, if the packet loss rate PLR exceeds the threshold value b (No at step S1202), subsequently, whether or not the packet loss rate PLR is equal to or less than the threshold value c is checked (step S1204). Here, if the packet loss rate PLR is equal to or less than the threshold value c (Yes at step S1204), the transmitting terminal 110 selects distribution of the same transmission data using the sniffer mode (step S1205).

Further, if the packet loss rate PLR exceeds the threshold value c (No at step S1204), the transmitting terminal 110 selects distribution of the same transmission data using the unicast communication (step S1206).

Then, the transmitting terminal 110 starts data transmission in the communication mode selected at step S1203, S1205, or S1206 (step S1207).

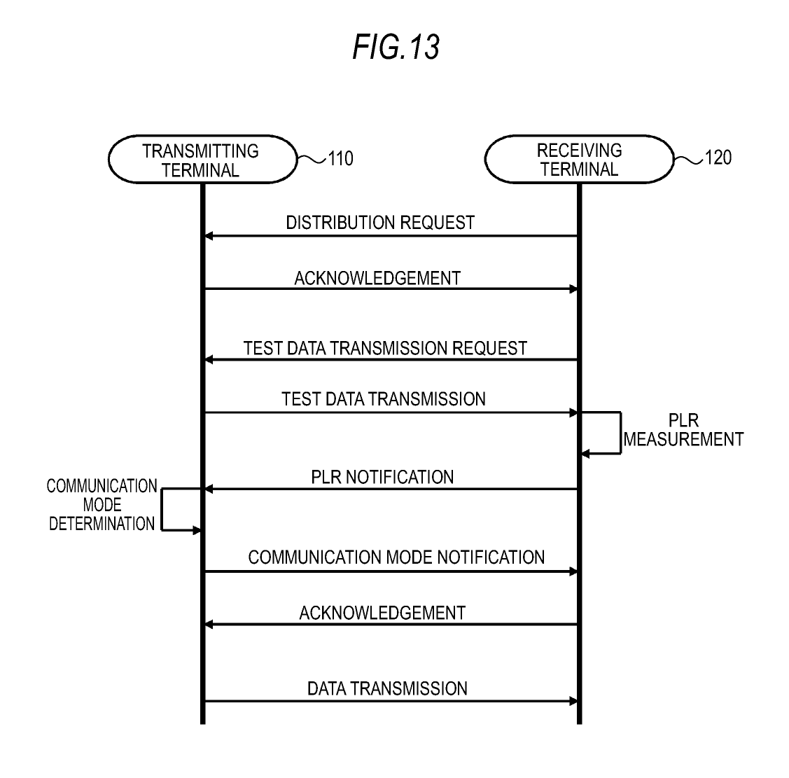

FIG. 13 shows a communication sequence example between the transmitting terminal 110 and the receiving terminal 120 when the communication mode is selected in response to the packet loss rate PLR as shown in FIG. 12A.

When the transmitting terminal 110 receives a distribution request of fixed delay data of real-time transmission of moving images or the like from the receiving terminal 120, the terminal returns an acknowledgement (ACK).

On the other hand, when the receiving terminal 120 that has transmitted the distribution request receives the acknowledgement (ACK) from the transmitting terminal 110, the terminal subsequently transmits a transmission request of test data.

The transmitting terminal 110 executes transmission of the test data to the receiving terminal 120 in response to reception of the transmission request of the test data.

Then, when the receiving terminal 120 receives the test data, the terminal measures the packet loss rate PLR and returns the measurement result to the transmitting terminal 110.

The transmitting terminal 110 determines the communication mode applied to the transmission of the fixed delay data, the distribution of which has been requested based on the packet loss rate PLR notified from the receiving terminal 120. For example, as shown in FIG. 11A, the transmitting terminal 110 compares the notified packet loss rate PLR with the threshold values b, c, and selects the multicast mode if PLR≦b, the sniffer mode if b<PLR≦c, and the unicast mode if PLR>c.

The transmitting terminal 110 notifies the receiving terminal 120 of the selected communication mode. In response, the receiving terminal 120 returns an acknowledgement (ACK). Then, when the transmitting terminal 110 receives the acknowledgement (ACK), the terminal starts transmission of the data, the distribution of which has been requested.

Note that, in wireless communication environments, the condition of the transmission line is not necessarily constant, and it is assumed that the packet loss rate PLR changes with the passage of time. As factors changing the condition of the transmission line, there may be interference with surrounding communication systems, movements of the receiving terminals 120-1, 120-2, . . . , 120-N within the communication system 100, increase and decrease of the number N of receiving terminals 120, etc. Accordingly, the measurement of the packet loss rate PLR and the selection of the communication mode are performed not only at the start of data transmission, but the measurement of the packet loss rate PLR and the selection of the communication mode may be repeatedly performed on a regular basis afterward.

FIG. 12B shows a processing procedure of measuring the packet loss rate PLR and selecting a communication mode on a regular basis in the communication system 100 in a form of flowchart. The processing procedure is performed in the transmitting terminal 110, for example.

The transmitting terminal 110 first sets the time counter to zero (step S1211), and measures the packet loss rate PLR in the communication system 100 (step S1212).

Then, whether or not the packet loss rate PLR is equal to or less than the threshold value b is checked (step S1213). Here, if the packet loss rate PLR is equal to or less than the threshold value b (Yes at step S1213), the transmitting terminal 110 selects distribution of the same transmission data using the multicast communication (step S1214).

On the other hand, if the packet loss rate PLR exceeds the threshold value b (No at step S1213), subsequently, whether or not the packet loss rate PLR is equal to or less than the threshold value c is checked (step S1215). Here, if the packet loss rate PLR is equal to or less than the threshold value c (Yes at step S1215), the transmitting terminal 110 selects distribution of the same transmission data using the sniffer mode (step S1216).

Further, if the packet loss rate PLR exceeds the threshold value c (No at step S1215), the transmitting terminal 110 selects distribution of the same transmission data using the unicast communication (step S1217).

Then, the transmitting terminal 110 ends setting of the communication mode at step S1214, S1216, or S1217 (step S1218), and starts data transmission.

Next, the transmitting terminal 110 updates the time counter (step S1219) and waits until the time counter reaches a prescribed value (No at step S1220). Then, if the time counter reaches the prescribed value (Yes at step S1220), the process returns to step S1211, and the above described processing of performing measurement of the packet loss rate PLR and the determination of the communication mode is repeated.

Note that the switching of communication modes is not necessarily performed on a regular basis as shown in FIG. 12B. For example, in the receiving terminal 120 in reception of the fixed delay data, the current packet loss rate may be indicated on the screen or using an LED (Light Emitting Diode) and the user may see and determine from the indication and set the switching timing of the communication modes. In either case, switching of the communication modes is performed in the middle of the data transmission by the transmitting terminal 110.

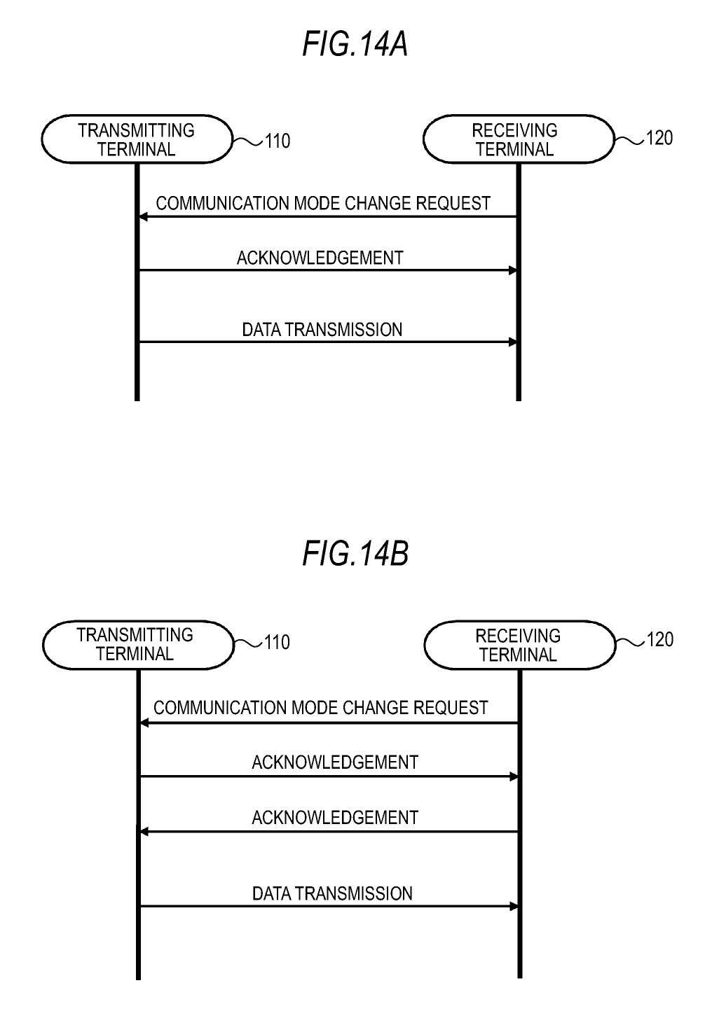

FIGS. 14A and 14B show communication sequence examples when switching of communication modes is performed in the middle of the data transmission by the transmitting terminal 110.

FIG. 14A shows a communication sequence example of switching communication modes in response to a request from the transmitting terminal 110. In this case, the transmitting terminal 110 transmits a change request of the communication mode to the receiving terminal 120. In response, the receiving terminal 120 returns an acknowledgement (ACK). Then, the transmitting terminal 110 receives the acknowledgement (ACK) from the receiving terminal 120 and confirms that the change of the communication mode is accepted, and switches the communication modes and performs data transmission.

Further, FIG. 14B shows a communication sequence example of switching communication modes in response to a request from the receiving terminal 120. In this case, the receiving terminal 120 transmits a change request of the communication mode to the transmitting terminal 110. In response, the transmitting terminal 110 returns an acknowledgement (ACK). Then, the receiving terminal 120 returns an acknowledgement (ACK) to the acknowledgement (ACK). Then, the transmitting terminal 110 receives the acknowledgement (ACK) from the receiving terminal 120 and confirms that the change of the communication mode is accepted, and switches the communication modes and performs data transmission.

Note that, in the communication system 100, for measurement of the amount of transmission delay, synchronization is established between the transmitting terminal 110 and the receiving terminal 120 (as described above). Therefore, by notifying the receiving terminal 120 from the transmitting terminal 110 or the transmitting terminal 110 from the receiving terminal 120 of the time when the communication modes are switched in advance, the transmitting terminal 110 and the receiving terminal 120 can switch the communication modes at the same time.

In this manner, in the communication system 100, when the data distribution of fixed delay data of moving image real-time transmission or the like is performed, the packet loss rate PLR with respect to each of the receiving terminals 120-1, 120-2, . . . , 120-N is measured, and thereby, the communication modes suitable for the condition of the transmission line can be selected, switched and the wasted band may be reduced, and the packet loss rate PLR may be reduced.

### <Ending of Service>

When the condition of the transmission line is deteriorated due to movement of the user or the like, the packet loss rate PLR of the receiving terminal increases. In the case where the receiving terminal under the deteriorated condition of the transmission line is a destination terminal of the unicast or the sniffer mode, retransmission may be requested by not returning the ACK to the transmitting terminal 110, or a retransmission request may be performed by returning a negative acknowledgement (NACK) to the transmitting terminal 110. However, in the case where the packets are lost even when retransmission is performed to the maximum times of retransmissions, the band is wasted and that causes reduction of the transmission chances of the other terminals. Therefore, it is preferable to remove the receiving terminals with increased packet loss rates PLR from the targets of service of fixed delay data distribution of moving image real-time transmission or the like.

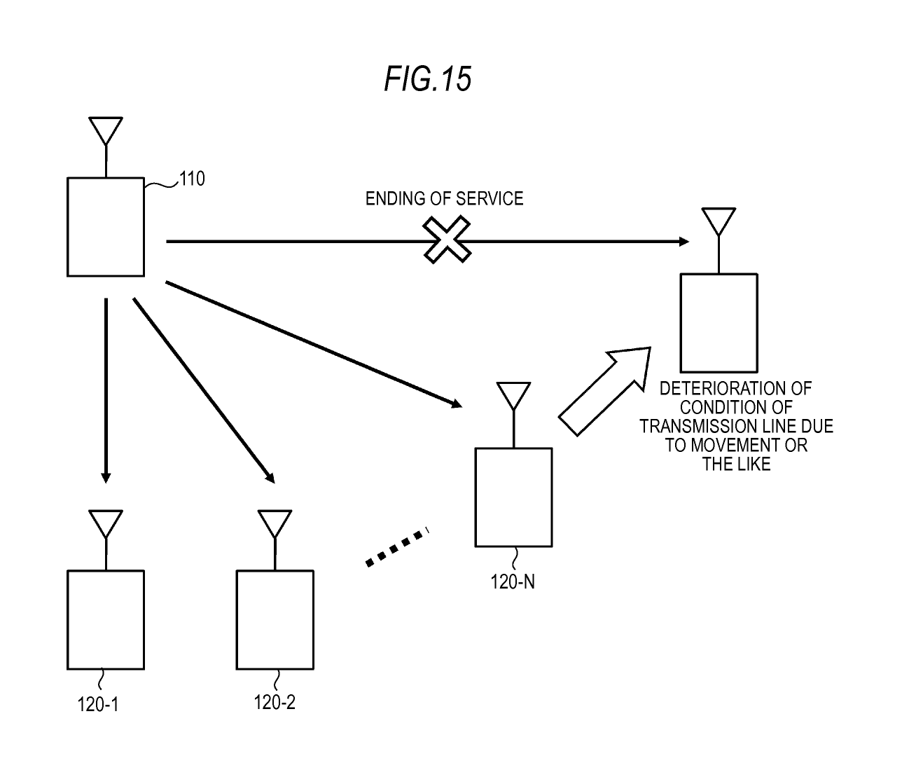

FIG. 15 shows a condition of ending service to a receiving terminal for which the condition of the transmission line is deteriorated due to movement in the communication system 100. In the illustrated example, in the receiving terminal 120-N, the condition of the transmission line is deteriorated due to movement or the like and the packet loss rate of the transmission data from the transmitting terminal 110 increases, and the service is ended.

As illustrated, by removing the receiving terminal 120-N under the deteriorated condition of the transmission line from the service, the transmission chances of the other receiving terminals 120-1, 120-2, . . . , 120-(N−1) can be maintained, and the data transmission quality of the entire communication system 100 can be kept.

Note that, regarding the receiving terminal 120-N removed from the service, if the condition of the transmission line is recovered due to movement of the user, reconnection of the service to the transmitting terminal 110 may be performed.

Further, in the case where the communication system 100 uses the sniffer mode and the receiving terminal 120-N as the destination terminal is removed from the service, another receiving terminal that operates as a sniffer terminal instead or one of the other receiving terminals 120-1, 120-2, . . . , 120-(N−1) that receives the same data by unicast is changed to a destination terminal. As described above, synchronization is established among all terminals within the communication system 100, and thus, ending of the service to the destination terminal and switching to a new destination terminal can be performed at the same time.

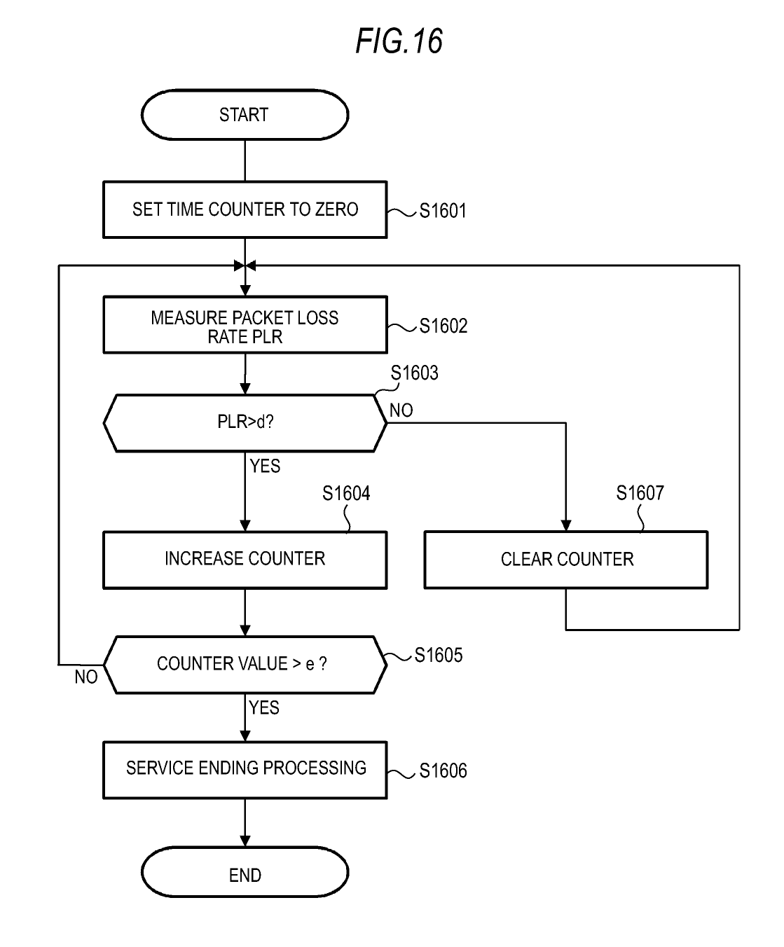

FIG. 16 shows a processing procedure of ending service to the receiving terminal 120 due to increase of the packet loss rate PLR in a form of flowchart. This processing procedure may be performed autonomously by the receiving terminal 120 measuring the packet loss rate PLR of itself or performed by the transmitting terminal 110 compiling the packet loss rates PLR of the respective receiving terminals 120-1, . . . . In the following description, a threshold value of the packet loss rate PLR with which whether or not the service is ended is determined is “d” and, when the number of times when the packet loss rate PLR continuously exceeds the threshold value d reaches “e”, the service is ended.

First, a counter that counts the number of times when the packet loss rate PLR continuously exceeds the threshold value d is set to an initial value zero (step S1601). When the processing procedure is performed by the transmitting terminal 110, the transmitting terminal 110 manages the counter with respect to each of the receiving terminals 120-1, 120-2, . . . , 120-N.

Then, the packet loss rate PLR of the receiving terminal 120 is measured on a regular basis (step S1602). For example, the transmitting terminal 110 transmits test data to the receiving terminal 120 on a regular basis and the receiving terminal 120 measures the packet loss rate PLR based on the reception result of the test data. When the processing procedure is performed by the transmitting terminal 110, the measurement results in the respective receiving terminals 120-1, 120-2, . . . , 120-N are complied in the transmitting terminal 110.

Next, whether or not the packet loss rate PLR of the receiving terminal 120 exceeds the threshold value d is checked (step S1603). Here, if the packet loss rate PLR is equal to or less than the threshold value d (Yes at step S1603), the counter is cleared (step S1607) and the process returns to step S1602. When the processing procedure is performed by the transmitting terminal 110, the transmitting terminal 110 clears the counter of the receiving terminal 120 with the packet loss rate PLR equal to or less than the threshold value d.

On the other hand, if the packet loss rate PLR exceeds the threshold value d (No at step S1603), the counter is increased (step S1604). When the processing procedure is performed by the transmitting terminal 110, the transmitting terminal 110 increases the counter of the receiving terminal 120 with the packet loss rate PLR exceeding the threshold value d.

Then, whether or not the value of the counter has exceeded e is checked (step S1605). Here, the value of the counter has not yet exceeded e (No at step S1605), the process returns to step S1602.

On the other hand, if the value of the counter has exceeded e (Yes at step S1605), ending processing of the service is executed (step S1606) and the processing is ended.

When the processing procedure is autonomously performed by the receiving terminal 120, the receiving terminal 120 with the counter value exceeding e executes the ending processing of the service of itself. Further, when the processing procedure is performed by the transmitting terminal 110, the transmitting terminal 110 executes the ending processing of the service on the receiving terminal 120 with the counter value exceeding e.

Note that the determination method of ending the service may not be performed by internal processing of comparison between the counter value and the threshold value e as described above, but may explicitly be performed by the user. For example, the counter value and the packet loss rate PLR may be indicated on the screen or using an LED (Light Emitting Diode) and the user may see the indication and determine whether to end the service or not.

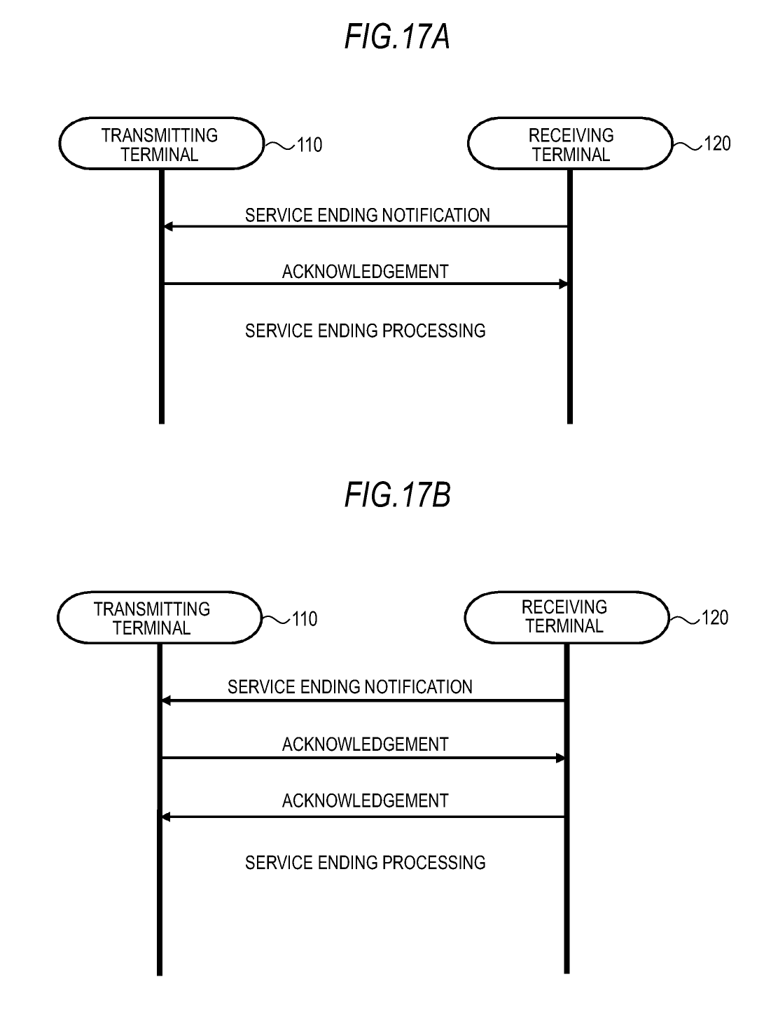

FIG. 17A shows a communication sequence example when service to the receiving terminal 120 with the increased packet loss rate PLR is ended. In the illustrated communication sequence, the transmitting terminal 110 notifies the receiving terminal 120 with confirmed increased packet loss rate PLR of service ending. In response, the receiving terminal 120 returns an acknowledgement (ACK). Then, the transmitting terminal 110 receives the acknowledgement (ACK) from the receiving terminal 120 and confirms that the ending of the service is accepted, and moves to ending processing of the service.

Note that the transmitting terminal 110 may notify the receiving terminal 120 the service of which is ended due to the increase of the packet loss rate PLR of service ending by superimposition on the transmission data of images or the like. According to the notification method, information may be notified to the user without addition of commands.

Further, FIG. 17B shows another communication sequence example when service to the receiving terminal 120 with the increased packet loss rate PLR is ended. In the illustrated communication sequence, when the receiving terminal 120 recognizes that the packet loss rate PLR of itself has increased, the terminal notifies the transmission terminal of ending the service to itself. In response, the transmitting terminal 110 returns an acknowledgement (ACK). Next, the receiving terminal 120 returns an acknowledgement (ACK) to the acknowledgement (ACK). Then, the transmitting terminal 110 receives the acknowledgement (ACK) from the receiving terminal 120 and confirms that the ending of the service is accepted, and moves to ending processing of the service.

Note that, in the communication system 100, for measurement of the amount of transmission delay, synchronization is established between the transmitting terminal 110 and the receiving terminal 120 (as described above). Therefore, by notifying the receiving terminal 120 from the transmitting terminal 110 or the transmitting terminal 110 from the receiving terminal 120 of the time when to move to the service ending processing in advance, the transmitting terminal 110 and the receiving terminal 120 can perform the service ending processing at the same time.

In this manner, in the communication system 100, when the distribution service of fixed delay data of moving image real-time transmission or the like to the plural receiving terminals 120-1, . . . is performed, the communication with the receiving terminal with the larger packet loss rate PLR is ended, and thereby, the wasted band may be reduced.

As above, the present disclosure has been explained in detail with reference to the specific embodiments. However, it is obvious that a person skilled in the art could alter or substitute the embodiments without departing from the scope of the present disclosure.

In the specification, the embodiments in which the present disclosure is mainly applied to data distribution of fixed delay of moving image real-time transmission or the like have been centered in explanation. For example, in IEEE 802.11aa, the standard technology relating to the wireless LAN that performs video data transmission is standardized, and the present disclosure may be applied to the wireless LAN system.

Note that the gist of the present disclosure is not limited to data distribution of fixed delay, but the present disclosure may similarly be applied to various communication systems in which one transmitting terminal provides distribution service of the same data to plural receiving terminals.

That is, the present disclosure has been disclosed in the forms of exemplification and the description of the specification should not limitedly be interpreted. To evaluate the gist of the present disclosure, the appended claims should be taken into consideration.

The present disclosure contains subject matter related to that disclosed in Japanese Priority Patent Application JP 2011-078462 filed in the Japan Patent Office on Mar. 31, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A wireless communication device comprising:
a data transmission unit that transmits data to one or more receiving terminals; and
a communication mode determination unit that determines a communication mode in which the data is transmitted from the data transmission unit,
wherein the communication mode determination unit selects a first communication mode in which unicast communication is used when the number of receiving terminals to which the data is transmitted is equal to or less than a predetermined number, and selects a second communication mode in which unicast communication is performed to one or some of receiving terminals as a destination and the other receiving terminals than the destination also receive packets in unicast communication when the number of receiving terminals to which the data is transmitted exceeds the predetermined number.

2. A wireless communication device returning an acknowledgement when receiving a packet to itself, and receiving a packet to another destination, but returning no acknowledgement when selected as a terminal that receives the packet to the other destination in unicast communication.

3. A wireless communication method comprising:
measuring the number of receiving terminals to which data is transmitted;
selecting a first communication mode in which unicast communication is used when the number of receiving terminals to which the data is transmitted is equal to or less than a predetermined number;
selecting a second communication mode in which unicast communication is performed to one or some of receiving terminals as a destination and the other receiving terminals than the destination also receive packets in unicast communication when the number of receiving terminals to which the data is transmitted exceeds the predetermined number; and
performing data transmission in the selected communication mode.

4. A wireless communication method comprising:
receiving data;
returning an acknowledgement when receiving a packet to itself; and
receiving a packet to another destination, but returning no acknowledgement when selected as a terminal that receives the packet to the other destination in unicast communication.

5. A wireless communication device comprising:
a data transmission unit that transmits data to one or more receiving terminals by unicast communication; and
a maximum number of retransmissions control unit that controls the maximum number of retransmissions in response to the number of receiving terminals as destinations of the unicast communication,
wherein the maximum number of retransmissions control unit reduces the maximum number of retransmissions of the receiving terminals when the number of receiving terminals increases.

6. The wireless communication device according to claim 5, wherein the maximum number of retransmissions control unit increases the maximum number of retransmissions of the receiving terminals when the number of receiving terminals decreases.

7. A wireless communication device comprising:
a reception unit that receives a packet as a destination of unicast communication; and
a retransmission control unit that performs retransmission control when the reception packet is lost in the reception unit,
wherein the retransmission control unit requests retransmission of the lost packet to the maximum number of retransmissions set in response to the number of receiving terminals as destinations of the unicast communication.

8. The wireless communication device according to claim 7, wherein the maximum number of retransmissions decreases when the number of receiving terminals as destinations of the unicast communication increases and the maximum number of retransmissions increases when the number of receiving terminals as destinations of the unicast communication decreases.

9. A wireless communication method comprising:
measuring the number of receiving terminals to which data is transmitted by unicast communication;
reducing the maximum number of retransmissions provided to the receiving terminals and performing unicast communication when the number of receiving terminals increases; and
increasing the maximum number of retransmissions provided to the receiving terminals and performing unicast communication when the number of receiving terminals decreases.

10. A wireless communication method comprising:
receiving a packet as a destination of unicast communication; and
requesting, when the reception packet is lost in a reception unit, retransmission of the lost packet to the maximum number of retransmissions set in response to the number of receiving terminals as destinations of the unicast communication.

11. A wireless communication device comprising:
a data transmission unit that transmits data to one or more receiving terminals; and
a communication mode determination unit that determines a communication mode in which the data is transmitted from the data transmission unit,
wherein the communication mode determination unit selects a second communication mode in which unicast communication is performed to one or some of receiving terminals as a destination and the other receiving terminals than the destination also receive packets in unicast communication when a packet loss rate in the receiving terminal is equal to or less than a first threshold value, and selects a first communication mode in which unicast communication is used when the packet loss rate in the receiving terminal exceeds the first threshold value.

12. The wireless communication device according to claim 11, wherein the communication mode determination unit selects multicast communication when the packet loss rate in the receiving terminal is equal to or less than a second threshold value lower than the first threshold value.

13. A wireless communication method comprising:
measuring a packet loss rate in a receiving terminal to which data is transmitted;
selecting a second communication mode in which unicast communication is performed to one or some of receiving terminals as a destination and the other receiving terminals than the destination also receive packets in unicast communication when the packet loss rate is equal to or less than a first threshold value;
selecting a first communication mode in which unicast communication is used when the packet loss rate exceeds the first threshold value; and
performing data transmission in the selected communication mode.

14. A wireless communication device comprising:
a data transmission unit that transmits data to one or more receiving terminals;
a packet loss rate measurement unit that measures a packet loss rate in each receiving terminal; and
a service ending processing unit that ends service of transmitting data to the receiving terminal with the higher packet loss rate.

15. A wireless communication device comprising:
a reception unit that receives a packet transmitted from a transmitting terminal;
a packet loss rate measurement unit that measures a packet loss rate in the reception unit; and
a service ending processing unit that ends service from the transmitting terminal when the packet loss rate is higher.

16. A wireless communication method comprising:
measuring a packet loss rate in each receiving terminal to which data is transmitted; and
ending service of transmitting data to the receiving terminal with the higher packet loss rate.

17. A wireless communication method comprising:
measuring a packet loss rate from a transmitting terminal; and
ending service from the transmitting terminal when the packet loss rate is higher.

18. A wireless communication system comprising:
a transmitting terminal that distributes data; and
one or more receiving terminals that receive data distributed from the transmitting terminal,
wherein the transmitting terminal distributes data in a first communication mode of unicast communication when the number of the receiving terminals is equal to or less than a predetermined number,
the transmitting terminal distributes data in a second communication mode when the number of the receiving terminals exceeds the predetermined number, and
the transmitting terminal performs unicast communication to one or some of the receiving terminals as a destination and the other receiving terminals than the destination also receive packets in unicast communication in the second communication mode.

19. A wireless communication system comprising:
a transmitting terminal that distributes data by unicast communication; and
one or more receiving terminals that receive data distributed from the transmitting terminal by unicast communication, and
reducing the maximum number of retransmissions of the receiving terminals when the number of receiving terminals increases.

20. A wireless communication system comprising:
a transmitting terminal that distributes data; and
one or more receiving terminals that receive data distributed from the transmitting terminal,
wherein the transmitting terminal distributes data in a third communication mode of multicast communication or in a second communication mode when a packet loss rate in the receiving terminal is equal to or less than a predetermined threshold value,
the transmitting terminal distributes data in a first communication mode of unicast communication when the packet loss rate in the receiving terminal exceeds the predetermined threshold value, and
the transmitting terminal performs unicast communication to one or some of the receiving terminals as a destination and the other receiving terminals than the destination also receive packets in unicast communication in the second communication mode.

21. A wireless communication system comprising:
a transmitting terminal that distributes data; and
one or more receiving terminals that receive data distributed from the transmitting terminal, and
ending service of distributing data from the transmitting terminal to the receiving terminal with a higher packet loss rate.
